(19) United States
(12) Patent Application Publication
(10) Pub. No.: US 2006/0218244 A1
(43) Pub. Date: Sep. 28, 2006

(54) Methods and systems for automating the control of objects within a defined human environment

(76) Inventors: Jung A. Rasmussen, San Antonio, TX (US); Matthew Arthur Rasmussen, San Antonio, TX (US)

Correspondence Address: KAMMER BROWNING PLLC, 7700 BROADWAY, SUITE 202, SAN ANTONIO, TX, 78209, US

(21) Appl. No.: 11/388,818

(22) Filed: Mar. 24, 2006

Related U.S. Application Data
(60) Provisional application No. 60/665,586, filed on Mar. 25, 2005.

(51) Int. Cl. G06F 15/16

(52) U.S. Cl. 709/218

(57) ABSTRACT

Methods and systems are described for the automation of a human living environment such as a home, an apartment, a workplace, or a vehicle. The methods and systems are directed to the control of various groups of objects within the human living environments according to defined criteria and defined object groupings, in a manner that establishes operational themes and scenarios within the environment. The methods and systems utilize devices for characterizing the environment (sensors), making decisions about actions appropriate in the environment (processors), and effecting actions and activities within the environment (switches, controls and actuators). The automation operates on multiple levels including; responsive safety functionality, one time action functionality, sporadically initiated timed action functionality, and periodically scheduled action functionality. The systems integrate with off-site information and action routing services that increase the decision making ability of the individuals within the environment.

### CROSS REFERENCE TO CORRESPONDING APPLICATIONS

This application claims the benefit under Title 35 United States Code §119(e) of U.S. Provisional Application No. 60/665,586 filed Mar. 25, 2005.

### NOTICE OF COPYRIGHTED MATERIAL IN DISCLOSURE

Portions of the material in this patent document are subject to copyright protection. The owner of the copyright does not object to reproduction of this document or of the patent disclosure as it appears in the Patent and Trademark Office files or records, but reserves all other copyright rights to the copyright owner.

### BACKGROUND OF THE INVENTION

1. Field of the Invention

The present invention relates generally to methods and systems for automation of a human living environment such as a home, a workplace, or a vehicle. The present invention relates more specifically to methods and systems for controlling groups of objects within human living environments according to defined criteria and defined object groupings so as to establish operational scenarios within the environment.

2. Description of the Related Art

Introduction

A home automation system has several purposes; these include increasing the utility of the home, making it safer, more comfortable, and convenient, and increasing the level of enjoyment for the homeowners and occupants. Early attempts at home automation produced independent devices and systems that each performed in a single functional area such as security, lighting, or entertainment. These offered only minimal capabilities with typically little flexibility. They were based primarily on relatively simple hardware with little or no software. They offered minimal configurability and usually required a technician to make alterations to the system, with no ability for the homeowner to (re)program the system behaviors. There was little or no ability to cross-connect such systems; their design typically did not include any such concept. In most cases, the costs of the usable systems were beyond the average homeowner's budget.

More recently home automation systems have emerged with increasing ability to support interconnections. These systems support some level of integration with other systems to enable cross-system functions. As a matter of course these systems have increased the types and number of features they support. These improvements bring new capabilities to such systems but have also increased their complexity. Whereas at one time a system had just a few capabilities and so just a few controls for the user to operate, it may now have complex sets of options and user interaction devices that can intimidate users of the system, especially those with special needs such as the disabled and elderly (as well as children and those who are ‘technology reluctant’). The systems have become increasingly complex to install and configure, even for trained professionals, and especially when they are called upon to interact with each other. The control system for a sophisticated lighting and window curtain control system has a much different approach and ‘feel’ than the controls for the security system; combining them together to operate in a manner that has a “smooth and easy feel” is not an easy task. Experience with consumers is showing that systems are installed but are either used at a minimal level (ignoring most of the advanced features) or simply not used at all. The causes for this are several; they include the complexity of the controls, the lack of a consistent approach from the user's point of view, counter-intuitive and inconsistent behaviors, and lack of ability to be tailored to the user's way of thinking.

Most home automation systems and devices are designed and implemented using very proprietary techniques, interfaces, and protocols. This greatly limits the ability for them to interact in an effective and complete manner. Many use proprietary data busses, older communications technologies, and similar technological approaches that impede the ability to interoperate in an effective way. There are a myriad of small technical details that must be overcome in order to build a truly integrated system with consistent behavior. In general, current devices and systems do not cooperate in a harmonious way; there is a need to provide some additional help to do so. There is a need to develop approaches and techniques that promote smooth integration across all devices and subsystems. Each should be treated in a consistent and similar manner, which in turn can allow the user to group and connect them in ways that make sense from a user point of view. For example, the system should support sending a command (e.g., “off” or “make brighter/raise the level”) to all devices or groups of devices; the system would interpret the command in the context of each device and perform the most useful and intuitive response for each device. The system should also allow the user to tailor the apparent behaviors of the device (for example, to specify the desired actions for behaviors that the devices do not directly support).

A related area is the sequencing of actions and operations with a system. Some current systems have the ability to schedule activities at particular, pre-specified times. This meets some needs but does not meet others. A more useful capability would be to allow a sequence of actions to be specified in “relative time” (that is, relative to a start time that is specified later each time the sequence is invoked). The sequence is thus freed from a fixed start or stop time. The capability would allow the sequence to be invoked at any time by one of several mechanisms (in addition to a simple scheduled time); these could include startup in response (1) to an event, (2) to relative time sequences defined within the main sequence, or (3) to the completion of some other sequences or actions. These should be definable by the user in an intuitive manner and should combine smoothly with system events, actions, and device controls.

Current home automation systems have become increasingly more powerful and complex, with substantial amounts of technician time required installing and configuring them. Some attempts have been made to allow the user (e.g., homeowner or resident) to perform these tasks, but the required level of technical ability and background required is still too high for the common person. There is a need for the system to be configurable by an average person having minimal technical background and experience (and likely having a relatively low level of interest in building or maintaining these).

Current systems are focused on the home and immediate premises. There has been no thought given to expanding the system past these borders. Some existing systems do support some capabilities for email and for accessing the resources of the Internet, but they do so in a manner that is either extremely limited (to the point of non-utility) or that assumes a nontrivial level of computer expertise (e.g., they provide access through a web browser and require the user to use the search engines such as Google to obtain information). The result is a system that feels unwieldy, disjoint, and jarringly inconsistent. There is a strong need for a system that presents information in a manner that is clear and simple. The presentation must mask the complex details of performing general searches using a search engine. It should focus on the areas of interest to a homeowner and on the city or region in which the home exists. Further, accessing such information should appear to be tightly coupled with other elements of the system; the user should not see a shift in the ‘feel’ of the system when accessing such ‘external’ resources. In addition, the system should be able to present relevant information when an event or situation arises within the home. For example, if the system detects a problem with the air conditioning system, it should be able to present information not only about the problem but also about local vendors who could remedy the problem. This should be done in a manner that is consistent and closely meshed with other aspects of the system operation.

A related area that has not been addressed in current systems is communication among peer systems. This would allow the system in one home to interact with another home's system. Doing so would allow the homeowners to participate in a “virtual neighborhood” that ties their homes together into a community. Homeowners could then watch over each other's properties as well as interact more easily with each other in a friendlier manner, something that modern life seems to be making more difficult. Members of an extended family could use such a capability to be more close-knit; siblings who are parents could look after each other's children, and elderly parents living in a separate home could be monitored by their children. In today's busy society, there is a strong need for such ability to interact and share each others' lives; the system could provide this. The system would need safeguards that allow the users to configure restrictions on the modes and types of sharing and interacting that are allowed (e.g., allow a close friend to change the temperature controls' settings of the home but allow a neighbor to only view the current home temperatures). Each home system could participate in several of these virtual communities, with different access controls placed on the members of each.

Another related area is the use of automation in vehicles. There is a need for a sophisticated vehicle automation system that operates in a manner similar to home automation. In addition, there is a strong need to tie the systems together into an automation environment that extends seamlessly from home to vehicle. Some of the automation facilities should appear identical in both settings (for example, the available library of music). Other facilities are “native” to one setting but should be accessible from the other. For example, car maintenance information is based on the vehicle's use and condition (e.g., miles driven) but should be integrated into the home system (e.g., a reminder in the home system to perform maintenance when mileage milestones are reached). There is a need for a vehicle system that performs such functions in close coordination with the home system. There is a concomitant need for the home and vehicle systems to interact in a cooperative and symbiotic manner. This would include a “vehicle dock” facility that would enable the systems to perform mutual discover and automatically commence and terminate interactions.

An important class of vehicle for many is the motor coach recreational vehicle (RV). (The same system is also applicable to towed recreational homes, but those parts that are related only to self-powered vehicles are omitted.) Although very similar in many ways to a hybrid combination of the home and vehicle systems, the RV environment has some unique features found in neither the home nor standard vehicles. These include items such as water tanks, parking/leveling jacks, slide-outs and other extensible parts, combustible gas supplies (e.g., propane), and special needs of travelers such as travel-oriented directory services and activity/trip multi-media logs. There is a need to provide an RV system that includes some features of both the home and vehicle systems but that also addresses these RV-specific areas.

A final area is the need for systems that provide the sophisticated features of the expensive current systems but at a price that is more affordable. A recently constructed large home (value approx. $1,000,000) included a lighting and home theater system that cost a significant fraction of the home's value (as much as $350,000); the labor cost just to “program” the system once the hardware was installed was well over $20,000. All programming was done by technicians due to the complexity and lack of end-user tools; changes to the system configuration must be performed by staff with the same level of technical expertise. The user has virtually no capability of altering the system behavior beyond its initial programming. There is a need for the capabilities of such systems to be made available at a more affordable price and to provide the ability for a non-technical user to make tailored alterations to the system without requiring a cadre of technical staff for support.

### SUMMARY OF THE INVENTION

It is an object of the disclosed invention to provide an intelligent home automation and management system having several unique features. These features allow users of the disclosed invention a wide range of powerful capabilities while simultaneously making the system simpler from the user viewpoint so that it is easier to use and understand. Another object is to use software-based techniques to reduce the overall cost of the system and the cost of installation and upgrades.

The disclosed invention in general interacts with a substantial number of other systems, devices, and sensors that range widely in the natures, purposes, and mechanisms. These may be included with the disclosed invention when it is initially installed or at a later time when the disclosed invention is updated or enhanced. In some cases elements will be already present when the disclosed invention is installed, which means they are incorporated into the sphere of influence of the disclosed invention at the time of its installation.

The disclosed invention has the goal of transforming the typical passive house into an active entity that has a presence almost as tangible as a living being. The disclosed invention has the feel of a quiet, very efficient personal assistant and butler—always available, never intrusive, always discreet, and private. The goal is to anticipate and meet each person's need almost before each is aware of it arising

The disclosed invention brings together every aspect of the home and the personal environment in a way not seen before. It is a hyper-integrated™ system, a level beyond normal integration of parts. The invention makes great effort to provide a great deal of power while minimizing complexity. It avoids the heavy, technical feel provided by so much of modern technology. Its design and implementation include much work to reduce the need for a user to “think technologically” in order to operate the system effectively. The goal is to avoid the “only the technologically savvy can operate it” feel seen in other systems.

The disclosed invention encompasses the home and all of its components plus all of the family vehicles, personal electronic devices, entertainment, and portable computing devices. These are seamlessly connected with remote data sources and services that offer an almost unlimited range of information access. Each person has access to home status and control, music and video entertainment, and information about the local business and entertainment environments, to name a few. There is very little in the home that cannot be placed within the invention's control and management, from security, lighting, heating, and air conditioning to outside devices (pool systems, sprinklers) to music and video systems. The disclosed invention offers all of these services and capability areas under a single system.

The disclosed invention's “everywhere coverage” can be extended to the family's vehicles as well as recreational vehicles (RV). The vehicle and RV elements of the disclosed invention have many of the features of the home system plus some that are specific to the needs of RV use and maintenance. The home, vehicle, and RV elements have the ability to communicate and exchange information. For example, maintenance requests generated by the vehicle or RV elements can be forwarded to the home element and brought to the attention of the appropriate member of the household (regardless of who actually used the vehicle or RV). In another example, the RV element can determine that it is time to perform routine maintenance on the RV based on elapsed time or mileage; this can be forwarded to the home system for presentation (e.g., as an alert notification).

The disclosed invention serves as a system of considerable power that reaches everywhere. It lets each person operate in an informational and entertainment environment through its presence in personal devices, vehicles, etc.—the system is always in contact. While listening to a morning radio show or a favorite CD, the invention provides continuity through the house and out to the car—uninterrupted delivery of entertainment.

The disclosed invention touches all aspects of daily life. It represents a new lifestyle, one that is based on information, and control whose presence is always available and very interactive and engaging. It offers the means to connect the family members as well as extended family and local community by means of carefully controlled shared access mechanism known as the “virtual neighborhood” capability.

The disclosed invention operates using a mechanism of combined awareness based on multi-sensory techniques, sensing real world states such as inside and outside temperature, light and daylight, and the movement of people. The invention uses smart correlation/relations of sensors: IR detection, wireless device use, use of lights, computers, and entertainment devices. It combines these with a history-based tracking (time of day, day of week, month, year) to create a full picture of daily life.

Other systems in the marketplace have some similarities with the disclosed invention. The inexpensive systems tend to be very fragmented, with minimal integration and cross connection among the parts. Expensive systems are available but are well beyond the means of most households; these systems are also generally oriented towards a business environment and lack the personal, intimate home ‘feel’ that is the hallmark ambience of the disclosed invention. In both cases the systems are too often hard to understand and use; they require users to have a mental model of the system that is complex and hard to remember. As a result, many times such systems are installed but used only at a small fraction of their potential. The disclosed invention is designed to be simpler and more direct, with careful attention to graphical user interface principles and an understanding of the cognitive load placed on the user by the system.

The disclosed invention is designed to be affordable and configurable for a wide range of home price ranges. This is a major factor of its nature and a key point that makes it attractive. It can be scaled in price and capabilities to meet a wide variety of needs, preferences, and financial means. It has a system architecture featuring ‘pluggable’ capabilities; enhancements and upgrades can be incorporated at any time.

The disclosed invention integrates with services offered and delivered through the Internet; it does so in a manner that is unprecedented in its smooth feel and depth of continuity. There are both no-cost and subscription based special services available. A central philosophy of the disclosed invention's design is to combine capabilities and information in a seamless manner so that the homeowner need not be aware of where the services are located—everything is in easy reach, accessible with minimal effort and great simplicity.

Most existing home control systems offer contact with the home environment but little else. The disclosed invention provides information not only about the home interior and exterior, but also the neighborhood (e.g., allowing one neighbor to watch the home of another neighbor while on vacation), the nearby locale (weather, local traffic, movie show times, local businesses, restaurants, entertainment schedules and venues), and beyond (travel information, national and international news and information). These are provided in a one-touch manner, without the need for clumsy, confusing, and time-consuming searching and clicking that is typical of current Internet access and search engines.

The disclosed invention provides for unique shopping experiences. It includes a mechanism for viewing and purchasing merchandise, ordering from restaurants (e.g., placing a ‘to go’ order by just touching items on the restaurant's menu), and similar transactions in a way that is integrated tightly into the user experience supported by the system.

This ability to combine elements together in a synergistic and natural way is a unique feature of the disclosed invention. It represents a leap forward from the disconnected and fragmented views provided by existing systems.

### BRIEF DESCRIPTION OF THE DRAWING FIGURES

This section describes briefly the content of each figure. The detailed description section that follows elaborates on their content. The drawings are engineering drawings for the system. The figures are replicas of the displays seen by a user when viewing the disclosed invention's graphical user interface displays.

Some blocks in the drawings are shown as labeled blocks with one or more additional blocks immediately behind and overlapped by the first block. This is intended to show that the disclosed invention includes one or more instances of the labeled block. For example, in FIG. 2 the home system 21 is shown as 3 overlapped boxes; this merely indicates that there may be one or more of these in the disclosed invention. The number of overlapped blocks is notional; no specific number of instances is implied by this convention.

FIG. 1 is an overview of the disclosed invention showing the main conceptual elements according to a preferred embodiment of the disclosed invention.

FIG. 2 is a physical deployment diagram showing the main components of the disclosed invention, how they are interconnected, and the context in which they operate. The latter includes related external systems not part of the disclosed invention but with which it interacts or interoperates.

FIG. 3A is an elaboration of FIG. 2 for the purpose of showing the physical deployment details of the home system component of the disclosed invention. FIG. 3A includes, for the purpose of continuity of context, several of the blocks from FIG. 2. It also introduces additional detail not shown in FIG. 2, primarily the systems, devices, and sensors with which the home system interacts.

FIG. 3B provides a further detailed block diagram demonstrating the physical components of the system of the present invention and the connections between these components.

FIG. 4A is a functional breakdown of the home server component shown as a single block in FIG. 3A. This figure shows the internal logical structure of the home server. Note that some elements from FIG. 3A have been included for context purposes; for brevity, some have been reduced in detail (primarily the sensors and devices) to reduce the complexity of the figure.

FIG. 4B provides a further schematic block diagram representing the functionality of the systems and methods of the present invention at the broad level of operation. The diagram provides a top level description of the operation of the methodology of the present invention as it gathers input, makes decisions, and carries out actions.

FIG. 5 is the functional layout of the system when operated in the “virtual neighborhood” manner. The figure shows those components from previous figures as needed to convey the concepts of this manner of operation.

FIG. 6 shows the vehicle docking concept and method of operation of the disclosed invention. It includes the home system, vehicle system, and RV system. The primary purpose is to show how these systems connect and interact when they are operated in the docking manner.

FIG. 7 is an elaboration of the vehicle system shown in FIG. 6. It serves a similar purpose to FIG. 4A, only for the vehicle system rather than the home system. The major functional blocks for the vehicle system are shown.

FIG. 8 is the functional breakdown for the RV system. It includes the components shown in FIG. 7 plus those that are added for the RV system.

FIG. 9 shows the main graphical user interface screen for the disclosed invention.

FIG. 10 shows the user interface to the resources repository, which accessed by the information access module (the Webpanion™ module) and is based on the use of an on-line information and connection service (the One Web Ring™ service).

FIG. 11 shows a typical business listing available through the information access module from the information and connection on-line service.

FIG. 12 shows the graphical user interface for a user notification known as an alert. The alert display includes both notification of a problem along with the on-line service business listings information provided by the information access module using information from the resources repository and the central servers.

FIG. 13 shows a typical Internet search for information about a restaurant. This is in contrast to the unique mechanism within the disclosed invention for locating such information in a much simpler, more useful manner.

FIG. 14 shows the main display of information from the Information and connection on-line information source as displayed by the information access module of the disclosed invention.

FIG. 15 shows the display that allows a user to specify criteria for selecting restaurants.

FIG. 16 shows the detail displayed used for specifying the cuisine criterion when selecting restaurants.

FIG. 17 shows the result of applying the selection criteria and obtaining a set of qualifying restaurants.

FIG. 18 shows a typical restaurant listing main display through the on-line information and connection module.

FIG. 19 shows a typical restaurant listing menu display through the on-line information and connection module.

FIG. 20 shows a typical restaurant listing pictures display through the on-line information and connection module.

### DETAILED DESCRIPTION OF THE PREFERRED EMBODIMENTS

This section contains a detailed description of the disclosed invention including its operation and functional breakdown. The unique features of the disclosed invention are noted and described with reference to the appropriate figures. In the description the terms user and homeowner are used. The general intent is that homeowner is used to specify a person with authority over the home and therefore having full access to all features of the disclosed invention. A user is any person that interacts with the system, regardless of the level of interaction (e.g., whether passively viewing a display screen or actively using input controls to affect devices or systems controlled by the disclosed invention). These terms are not used rigorously; they are intended to show at what points and in what manner a human interacts with the disclosed invention.

The disclosed invention the capability to communicate in various ways using various media, as appropriate to the system or device with which interactions take place. The disclosed invention is not dependent upon any precise medium used for such communications; it is designed to ‘hide’ the actual mechanism. In the description below, the communication media mentioned are for a preferred implementation of the disclosed invention; they should not be interpreted as exclusive of other media in any way. For example, the description refers to the Internet as a public medium over which parts of the disclosed invention communicate; in fact, this communication can occur over any suitable wide-area network (public or having some type of limited access). Rather than clutter the description with constant reminders, the preferred implementations for communications are cited as representing any suitable medium that can perform the required function.

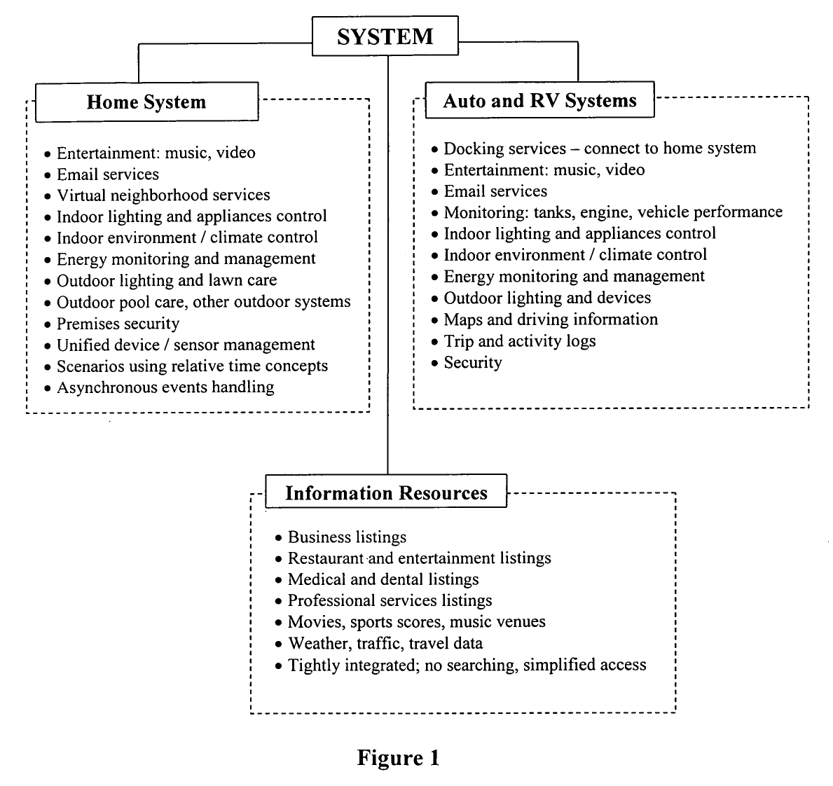

FIG. 1 gives an overview of the disclosed invention showing the main conceptual elements. It lists in conceptual form the main features provided by the disclosed invention. These are grouped into the Home System, the Vehicle/RV system, and the Information and connection services. Each of these is discussed in detail in the following paragraphs.

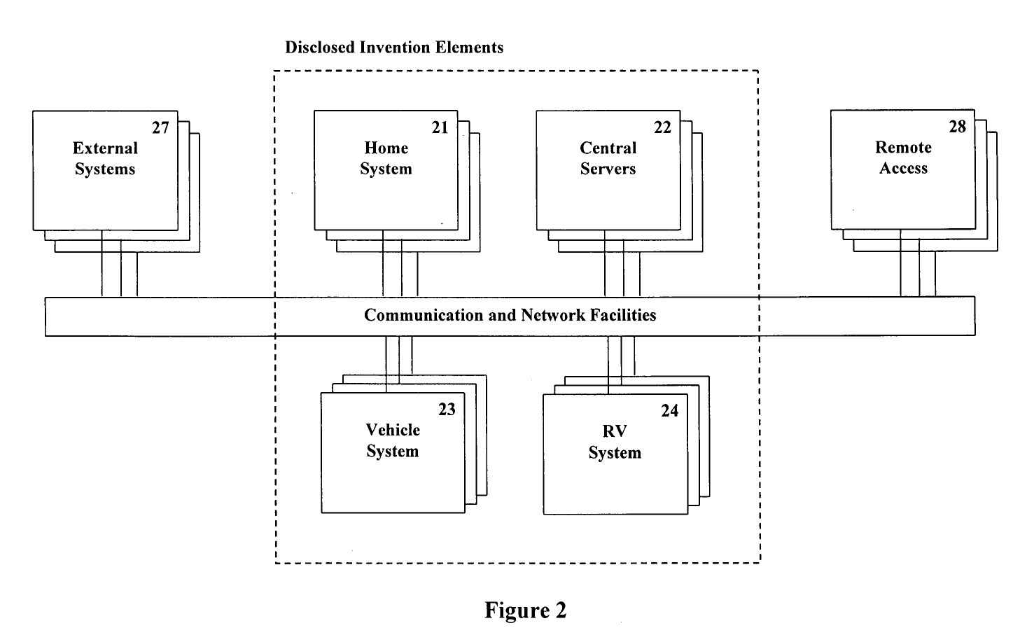

FIG. 2 shows the overall physical configuration for a preferred embodiment of the disclosed invention. The invention comprises at least one home system 21 and at least one central server system 22; the invention may include an optional vehicle or RV systems 23. The home system 21 is installed in a home (house, condominium, apartment, or similar abode); the central system is installed in a provider facility supplied by the inventor or designated agent. These entities communicate with each other using available communications and network facilities 29. The latter are typically IP-based networks including public segments (the “Internet”) but may be any suitable communication medium.

The home system 21 obtains a variety of ‘update’ information from the central server 22; this can include news, weather, traffic, sports scores, movie show times, software updates, and similar items. The home system 21 provides to the central server 22 selected information about its status, configuration, and operation for backup and analysis purposes.

The system also supports remote access 28 by external users (those outside the home environment). An example case include a homeowner using remote access 28 to access his home system 21 or vehicle/RV system 23 for the purpose of monitoring or controlling them. Another example is a service technician using remote access 28 to perform system diagnostics, upgrades, or maintenance.

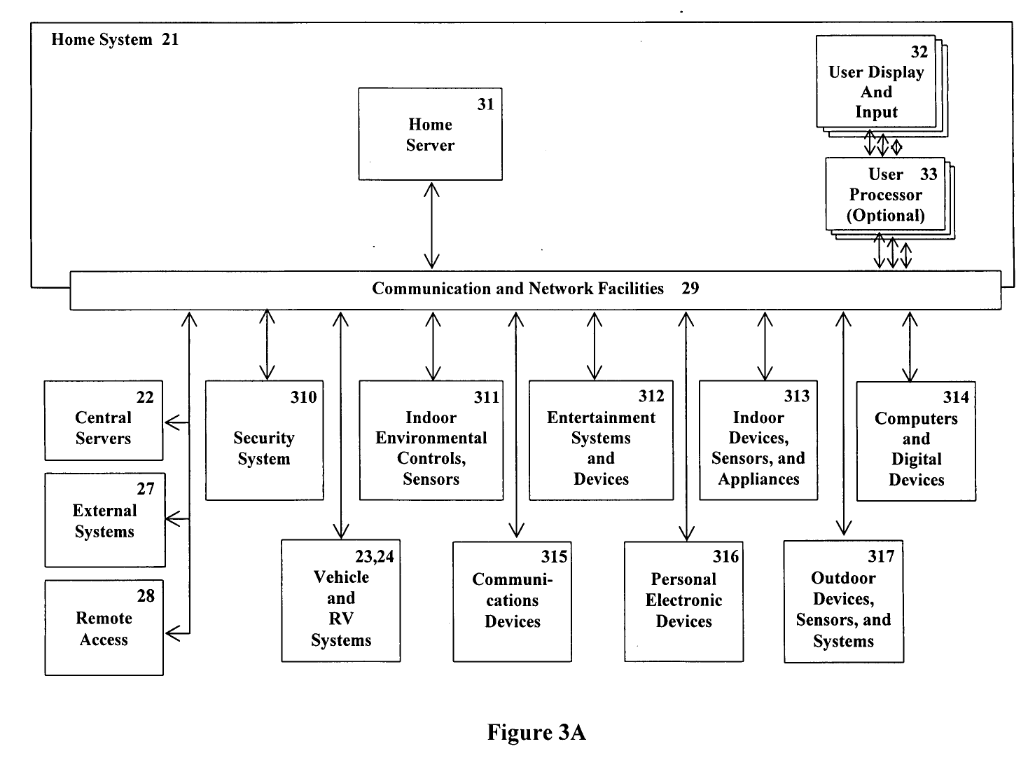

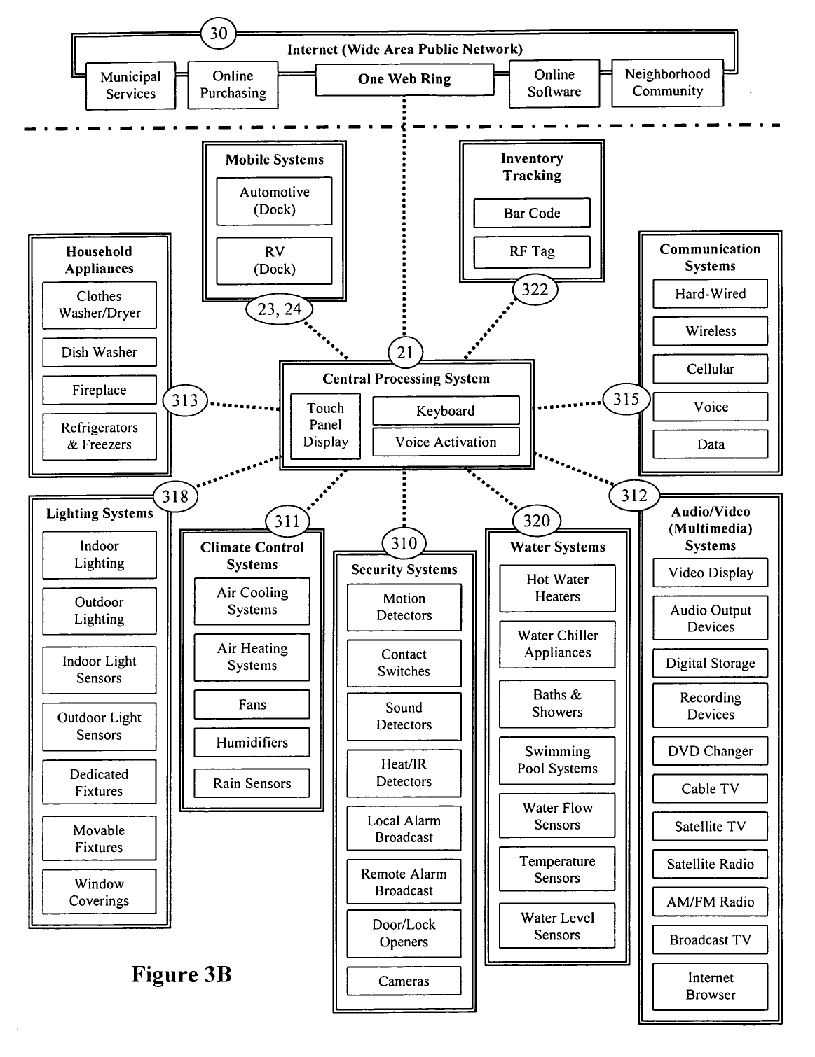

FIG. 3A shows a typical physical deployment of the home system 21 component of the disclosed invention. The home system 21 includes these components: home server 31, client display and input items 32, optional client processors 33, and communications components 29 used to interconnect the other components. The home system 21 interacts with a variety of subsystems and devices as shown in FIG. 3A. These include both entities that are sold as part of the disclosed invention and those that are obtained from other sources. For example, the block Computers and Digital Devices 314 can include both computer devices installed as part of the installation of the disclosed invention as well as computers purchased by the homeowner and integrated into the overall system.

The number of systems, subsystems, and devices with which the disclosed invention communicates is quite large. The blocks in FIG. 3A represent generic classes of such entities (blocks 310 through 317). For context the figure also shows other entities with which the disclosed invention interacts (blocks 22, 23, 27, 28); see also FIG. 2 which shows these same entities.

The systems, subsystems, and devices represented by blocks 310 through 317 in FIG. 3A include a wide variety of items; each block represents a category of such items. The following are examples of items for each block and additional details on how the disclosed invention interacts with them.

The security system 310 is typically a conventional security system that monitors the home (doors, windows, motion, etc.) and provides an alarm notification to occupants if security is breached. It typically is also monitored remotely by a security service that receives alarm notifications as well so that assistance can be summoned (police, fire, etc.) The disclosed invention also is capable of monitoring and controlling the security system 310 including arming, disarming, and displaying alarm notification information using the client display and input items 32.

Indoor environmental controls and sensors 311 include items such as indoor environmental sensors (e.g., temperature, humidity, and air flow), thermostats, and other heating/air conditioning sensors and controls, and similar items. This grouping includes a wide variety of sensors and subsystems; for example, it can include “people trackers” to show where persons are in the house. The disclosed invention monitors these sensors and can be programmed by the user to react when various events occur (e.g., a temperature exceeds a limit under specific circumstances).

Entertainment systems and devices 312 include a wide variety of entertainment and related items. Examples include audio and video sources and players, distribution devices and controls, media storage devices and controls, and communications devices used to interact with such entities such as infrared (IR) and radio frequency (RF) (also known as ‘wireless’) devices. The disclosed invention has driver entities that are able to interact with each of these items, allowing them to be sensed, controlled, and operated under the directions of commands and actions programmed into the disclosed invention (by either a technician or a member of the household).

Indoor devices, sensors, and appliances 313 include nearly any indoor system or device that can be sensed or operated using electricity. Typical items include lamps, lights, and lighting controls; motorized curtains and similar portal coverings; fans, heaters, and the like; and video and surveillance cameras and microphones.

Computers and digital devices 314 include any computerized system that is capable of interacting with another computer. Typical items include tablet computers, laptop computers, desktop computers, and personal digital assistants (PDA). The most basic interaction is by use of a web-based browser, which the disclosed invention supports by providing access to functions using web pages. The primary purpose is to allow such devices to serve as additional client devices for displaying state information and controlling the disclosed invention, but other functions are also available such as use of such devices for data storage (e.g., for entertainment data such as music data).

Communications devices 315 include telephones, “smart” and cellular telephone devices, and telephone exchanges and answering systems. The disclosed invention interacts with them to obtain status from them (e.g., incoming calls whose numbers can be displayed on client displays 32) or control them (e.g., to silence incoming calls during specific times as specified by the homeowner to the disclosed invention).

Personal electronic devices 316 include personal entertainment devices, and other devices such as games. The disclosed invention interacts with them to provide media (e.g., download music to a personal player).

Outdoor devices, sensors, and appliances 317 include nearly any outdoor system or device that can be sensed or operated using electricity. Typical items include outdoor lights and lighting controls, motorized curtains and similar portal coverings, fans, heaters, pumps, and the like. As an example, a common outdoor area in which these kids of devices and systems are found is a swimming pool or hot tub area.

FIG. 3B repeats much of the description and disclosure of FIG. 3A with additional detail on the specific components that may be present in the higher level systems connected together in the present invention. The components include both devices that gather information or data (sensors, for example) and devices that carry out actions (switches and actuators, for example). The component listings are intended to be representative only and to suggest other like devices and components that are typically found in the modern human living environments of concern. FIG. 3B also provides a schematic representation of the connections between the individual environment (and/or small cluster of environments) and a wider area network such as the Internet. The environment shown in FIG. 3B is typical of a “single family dwelling” environment as that term is commonly used in the description of property. It is understood that the actual number and relations of the occupants of the defined human environment (the home, the apartment, etc.) will vary greatly from one to many. That is, the occupants may or may not actually comprise a single family and yet may find the so-called single family dwelling an appropriate environment. The environment shown in FIG. 3B may also be instructive of the detailed systems that might be found in the motor vehicle environment, the RV environment, or any combination of these discrete defined human environments such as condominiums, apartment complexes and even work spaces.

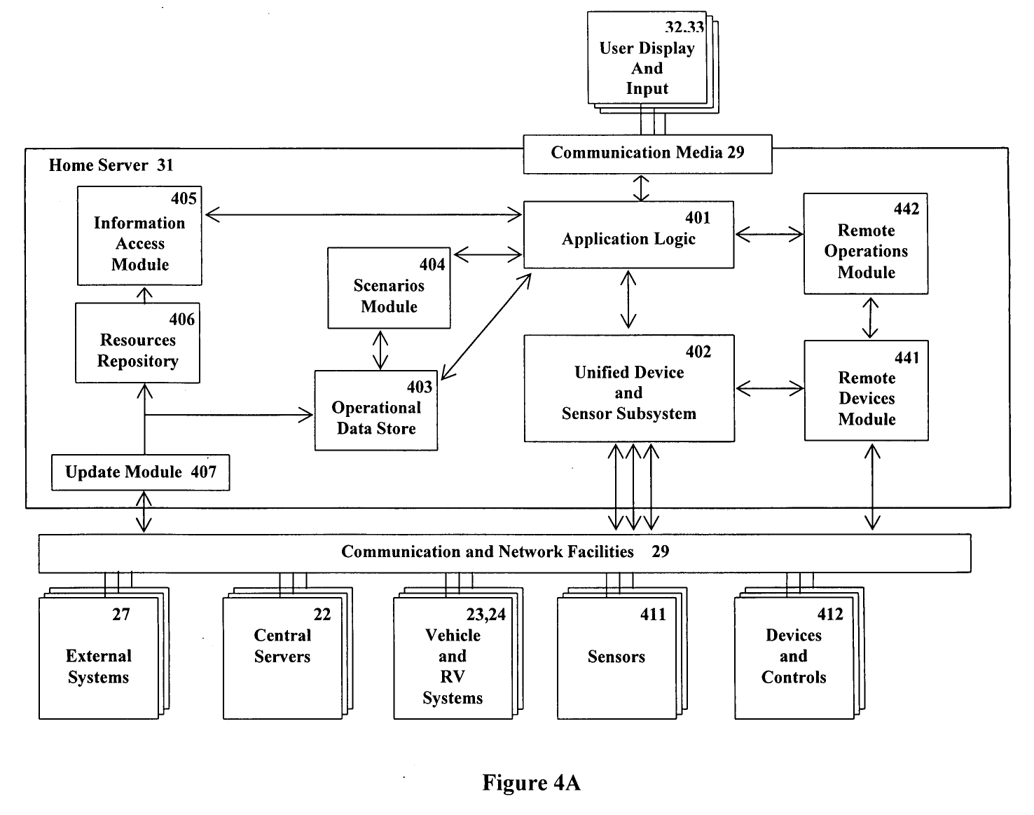

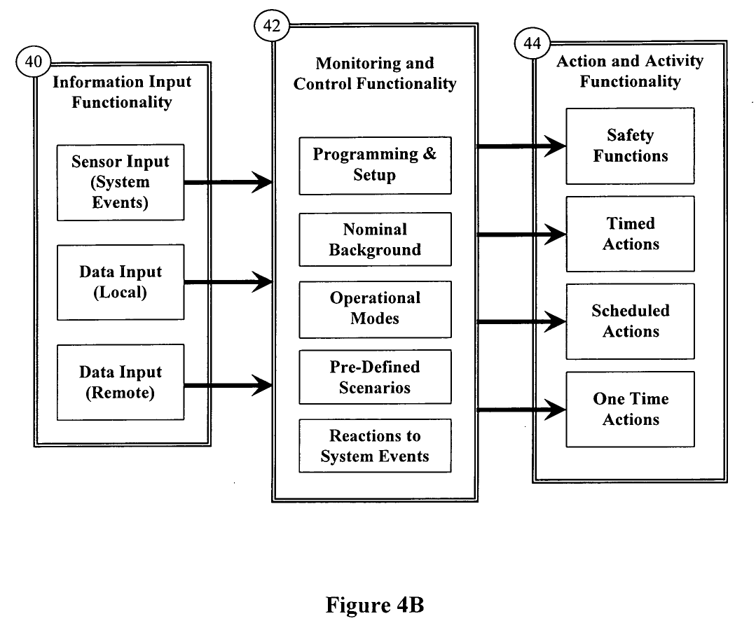

FIG. 4A shows the functional component blocks of the home server 31. The preferred implementation of the home server uses a general purpose computer on which is running a multi-tasking operating system. The computer also has the communication interfaces required to interact with the various systems and devices. The latter appear in FIG. 3A as blocks 310 through 317; for brevity they are represented by blocks 411 (sensors) and 412 (devices and controls) in FIG. 4A. Note that the communication media 29 used by the home serve 31 to interact with sensors 411 and devices 412 are whatever media are required to do so. The preferred implementation of the disclosed invention uses IP-based network communication (wired or wireless) supplemented by serial communication (e.g., RS-232), infrared (IR), and special radio frequency (RF). Examples of these include wired and wireless Ethernet networks, power line RF signaling systems, telephone systems such as private branch exchange using analog or digital communication, and IR handheld remote control devices.

Blocks with numbers 401 through 406 in FIG. 4A represent functional areas of the home server 31. The preferred implementation uses software functions for these. The application logic 401 is the main set of programmed logic that operates the server. The unified device and sensor subsystem 402 contains device controllers and device drivers for the various devices with which the server interacts including the sensors 411 and devices and controls 412 as well as special devices such as the interface to the vehicle and RV systems 23.

The operational data store 403 contains the operational data that supports the application logic 401 and other functions of the server. A large portion of the data in the data store is saved in persistent form in the home server 31 file systems. The scenarios module 404 contains the functions associated with scenarios, house modes, device groups, schedules, and event handling. A scenario is a unique feature of the disclosed invention that allows devices and groups of devices to be acted upon in a special manner. A detailed description of this feature follows.

In describing a scenario, several related concepts must be defined. An event is an asynchronous happening that originates from one of several sources. A real world event occurs when something happens in the real world that is sensed by the system (e.g., a motion sensor is tripped, the phone rings, a power level sensor reaches a specific level and sends a signal, a light switch is activated). A synthetic event (also known as an internal event) is generated within the system (e.g., detection of a system anomaly, firing of a reminder event). A combination event is a combination of several other events. The system permits specifying an action to occur when an event is sensed. It also permits attaching qualifying criteria such as time criteria (e.g., the event is propagated only during certain hours of the day.)

Another key concept related to scenarios is an action. An action is an activity the system performs. Actions include several types:

(i) activating/operating a device or group of devices

(ii) starting or stopping a scenario

(iii) activating or deactivating a schedule

(iv) display a page (e.g., a page from the information and connection on-line service) with an annotation (an alert)

When a schedule is deactivated, the schedule's associated action is stopped if active. In addition the schedule is set to not start again until a specific condition is met (e.g., until manually re-enabled or until N occurrences of its normal starting have occurred and therefore ‘skipped’). Some examples of actions are turning on a light, sending a “play” command to a group of devices, deactivating a schedule, creating a new group of devices, sending a text page to a user's PDA, etc. An alert is a special type of action that notifies user(s) that something of interest to the users or something needing human attention is present or has occurred.

Given the above descriptions of concepts, a scenario is described as a sequence of actions that are defined together with particular relations among them. The sequence is based on “relative time” rather than absolute time. That is, the scenario can be started at any time; its sequence is then defined relative to that start time. (A scenario therefore never specifies an ‘absolute time’ such as noon, February 25. The absolute times are determined dynamically each time the scenario is activated.) The actions within a scenario are sequenced in two ways: either relative to the start time or relative to the previous action within the scenario. The activation of each action of a scenario is specified as (1) a time interval of specified length beginning at the start time of the scenario, (2) a time interval of specified length beginning at the time of activation of some other action of the scenario, or (3) the occurrence of a specified event at any time during the scenario's lifetime. In case 3, the activation can be qualified such that action A2 is activated upon the first occurrence of a specified event that occurs after the activation of another action A1. Case 1 example: action “turn off light L3” is activated 10 minutes after the scenario's start time. Case 2 example: action “turn on light L3” occurs 10 seconds after previous action “turn off television TV5” occurs. Case 3 example: action “turn on hot tub pump P3” occurs at event “hot tub temperature has reached 120 degrees” but only after event “turn on hot tub heater” has been activated. Starting or stopping a scenario is considered an action; a scenario can therefore activate another scenario (or even another instance of itself). A scenario is typically started by a triggering event or by a schedule (it may be manually started as well).

The disclosed invention includes a unique feature for providing information to users of the system. The information access module 405 is an active agent that uses the content of the resources repository 406 to provide a wide variety of useful information. The information access module has several aspects that operate synergistically, which is a key to its uniqueness. It features a fully integrated information directory service that contains primarily information about the city or region in which the home is located. This feature allows users to locate and get highly-detailed information about local businesses, restaurants, medical/legal/business professionals without the need for lengthy searching. It provides a pictorially-based, step-by-step approach to locating information. This represents a simpler and more effective means than other systems, which typically use text-based searching based on keyword lookups.

The information access module 405 is more than just a passive, ‘the user must ask it’ information source. It is an integrated part of the system, not a separate entity. There is direct interaction of the information access module component with other system components. For example, a system alert can be received by the information access module, which it turn results in an unsolicited display of an information page; no action is required by the user. For example, the information access module can provide displays of a medical doctor's information ‘page’ when a system reminder is triggered to visit that doctor for a routine physical. Similar examples include the information access module displaying movie show times for local area theaters during a ‘party time’ scenario when triggered by an event, a time, or a manual action. The information access module can provide information for HVAC vendors when the disclosed invention detects a fault in the heating/air conditioning system. A more complex example is the automated ordering of pizza from a local pizza vendor by triggering the information access module as part of a ‘party time’ scenario. A unique feature of OWR includes the specialized, integrated presentation that uses a button-operated, pictorially-oriented means to display and access the OWR information. This is substantially easier and faster than typical directory listings.

A key internal feature of the information access module 405 and associated resources repository 406 is its design as a pre-organized, pre-categorized, and pre-cross-referenced information repository. This allows the information access module to locate information more quickly and in a more targeted manner than the general purpose ‘search engines’ that are typically in use today.

Another distinguishing feature of the information access module 405 is the large amount of detail. All businesses and restaurants are categorized based on relevant attributes including name, occupation/service, location, pricing, cuisine, specialties, current specials, atmosphere, menu selections, and entrée names. Each business listing includes all of the following (which are applicable to the business): name of business, address, phone/fax/cell numbers, region location, hours of operation, pricing, specialties and medical/professional specialties, website address, description, biography, email address, education, complete breakfast/lunch/dinner menus with entrée descriptions and prices, desert lists, wine lists, driving directions, map of street location, images, services rendered including takeout, delivery, catering, reservations, and smoking availability. For merchants that support it, the information access module 405 can be used to purchase products including items from restaurants, groceries from grocery stores, and merchandise from both online and local merchants.

The resources repository 406 used by the information access module 405 contains information as described in the previous paragraphs. This includes information about local businesses, professionals, restaurants, entertainment venues, points of interest, and similar entities. It also contains information that is regularly updated such as local area theater movie show times, sports scores, weather, traffic conditions, travel conditions, and more. This information is updated on a routine basis by the update module 407 which interacts with services provided by the central servers 22 to obtain the updated information.

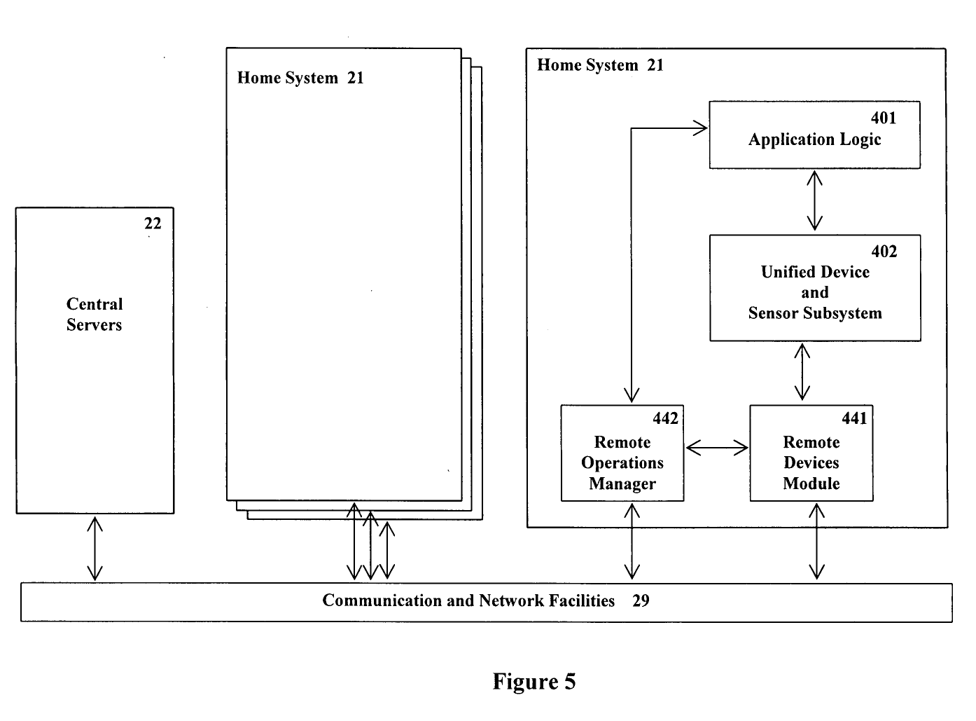

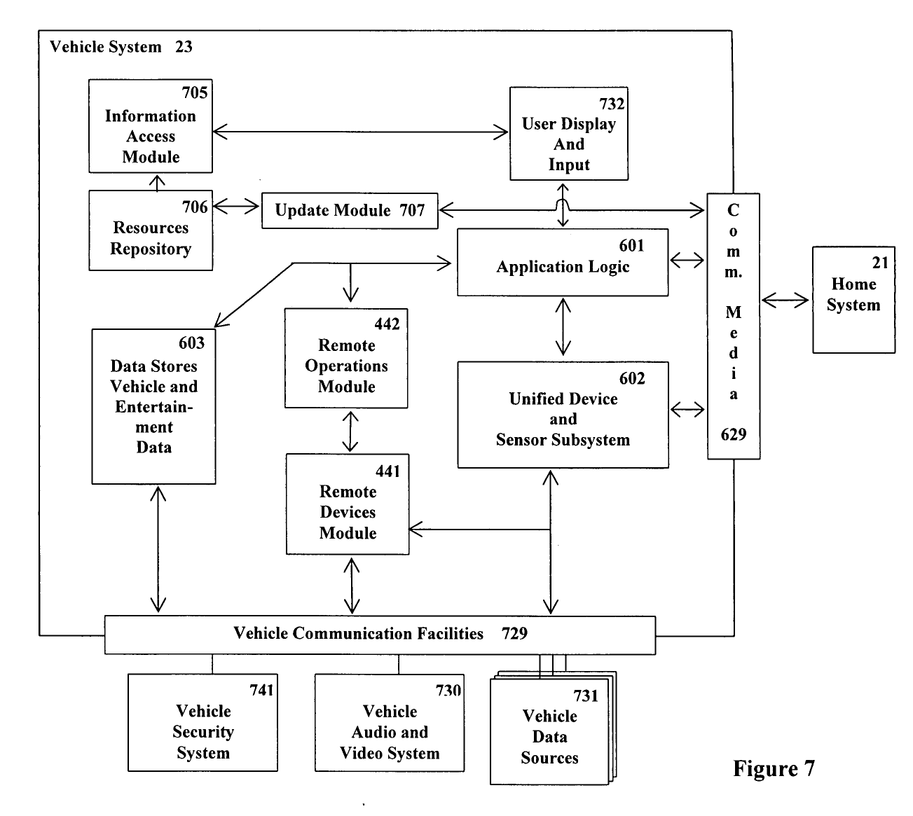

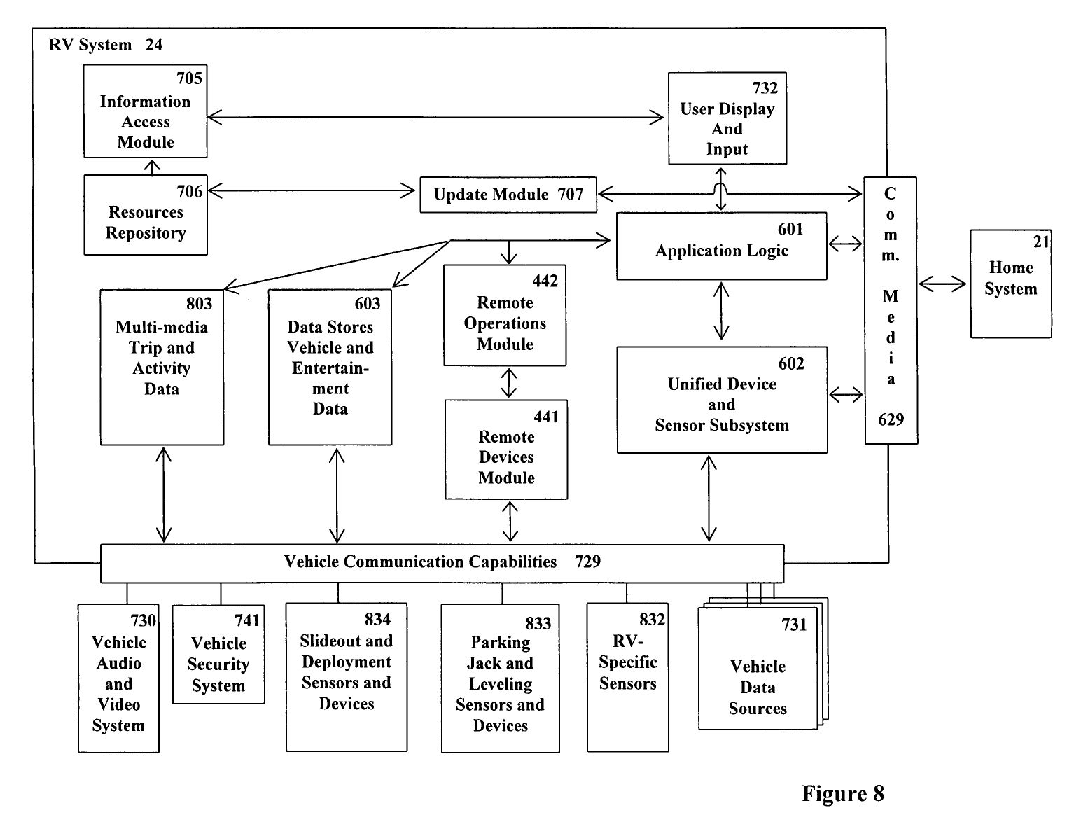

FIG. 4A also shows the remote devices module 441 and the remote operations module 442. These allow the home system 21 to interact with other systems that are compatible with the disclosed invention. A key feature is the ability of the home system 21 to view devices on other systems as though the devices were part of the local environment (rather than being located remotely). For example, this allows a device group or a scenario (see scenarios module 404) to operate both local and remote devices without requiring special operations or handling. Most important among these are other home systems 21, which form the “virtual neighborhood” described in the following section that describes FIG. 5. These modules are also used in conjunction with the vehicle and RV systems as shown in FIGS. 7 and 8.

FIG. 4B provides a description of the broader methodology of the system of the present invention. In this functional diagram, the three broad level functionalities of the system are disclosed. The core of the system from a functional standpoint is its ability to carry out monitoring and control functionality 42. This core is the decision making functionality or the cause and effect functionality that links the sensed environment with the actions carried out within the environment. The environment is taken in or sensed by the system through the information input functionality 40 that includes sensor input of system events as well as both local and remote data input. Local data input may be as simple as user touch screen input or may be more complex, such as voice activated commands. Remote data input may be as simple as a remote terminal link or more complex, such as a download file that is conveyed to the system.

The action and activity functionality 44 of the system may be broadly identified as all the functionality that brings about an “effect” within the environment at the direction of the automated system. These may be broadly categorized as safety functions (operational safeguards that involve directly linked cause-effect functions), timed actions (often related to the defined scenarios involving a sequence of actions initiated at a non-specific point in time), scheduled actions (scenarios or themes based on time-of-day and/or day-of-the-week timelines), or one time actions (initiated apart from any pre-programmed schedule or scenario). The discussions hereinabove and below provide further detail on the manner in which these actions and activities are carried out in these various ways.

FIG. 5 shows another unique facility of the disclosed invention, the “virtual neighborhood” capability. The home systems 21 of two or more homes can be interlinked to allow the inhabitants to interact using the interconnection. Devices and sensors operated within one home system 21 can be controlled by the users of a different home system 21. This allows the participants in the ‘neighborhood’ to treat each other's habitations as extensions of their own. For example, they can look after each other's houses, checking on the same kinds of things as they would for their own home: security, light, power consumption, etc. The level of interaction and sharing between home systems 21 can be controlled to allow certain types of access from one home to another but block other types of access. For example, one home system 21 may be set by the homeowner to permit access by a neighbor but only at certain times (e.g., during work hours one neighbor can look in on another's home or check on children home from school; during vacations, one person can monitor another's home in their absence). The access can be limited to certain devices (e.g., only the security system and house temperature sensors) as well as limited to passive access without the ability to operate any controls (e.g., to be able to monitor thermostats and temperature in the home but not alter their settings). This allows setting the level of ‘intimacy’ and privacy, allowing very wide access to an elderly parents home but quite limited access to casual neighbors. This capability can be used by any group of home systems 21 and is possible regardless of the physical distance between homes. Each home system 21 may participate in a number of such ‘virtual neighborhoods’. The purpose of the capability is to enable modern households to share their environments, making for a more closely-knit circle of family, friends, and neighbors.

The virtual neighborhood operates as shown in FIG. 5. The participating home systems 21 are shown; one of the participants is shown in additional detail to reveal functional modules that support the neighborhood's operation. The intercommunication between home systems 21 is enabled by special device drivers used by the unified device subsystem 402; these are shown as remote device modules 441. The modules operate on a proxy basis, forwarding control operations to their peer components in other home systems 21 and receiving sensor and status information from them. The interconnection process is overseen and controlled by the remote operations manager 442, which provides control over levels and types of access based on policies set by the homeowner. As noted previously, the application logic 401 contains the primary program logic for the server. The application logic 401 uses the remote system devices as though they were located in the local home system 21 for most operations. The application logic 401 uses the remove operations manager 442 to query the properties of the interactions with remote home systems 21 as well as to control the interactions as needed. This allows, for example, a scenario in one home system 21 to operate devices in a remote home system (as well as simultaneously operating local devices).

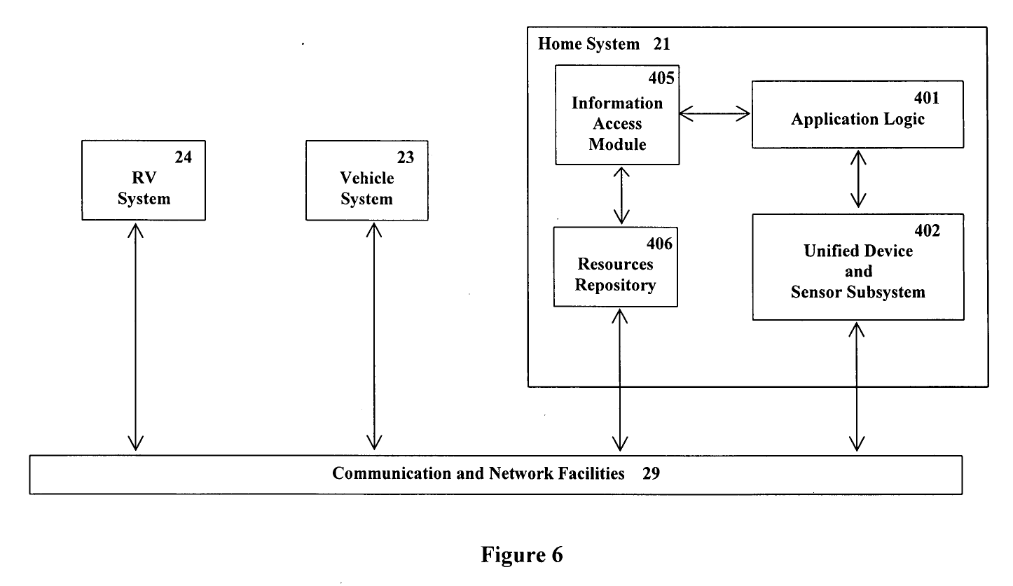

FIG. 6 shows an overview of the vehicle system 23 and the recreational vehicle system 24 together with the vehicle docking capabilities of the disclosed invention. The vehicle system is a version of the home system 21 that has been adapted to the private automobile, truck, and sport utility vehicle environments. The primary goal of the vehicles systems is to provide an extension of the experience provided by the home system 21 into the homeowner's vehicles. Its capabilities are described below as part of the description of FIG. 7. The main purpose of FIG. 6 is to show how the vehicle system 23 and recreational vehicle system 24 are able to interact with the home system 21 using a ‘vehicle docking’ technique. This is a unique aspect of the disclosed invention. In the following the docking process is described for the vehicle system 23 but applies as well to the recreational vehicle system 24.

Note that for clarity FIG. 6 does not show the remote operations manager or remote devices module; refer to FIGS. 4A and 7 for these details.

The docking process allows the vehicle system 23 to connect and disconnect automatically from the home system 21. The purpose of the interconnection is to allow the two systems to exchange information. This includes the extracting vehicle performance and operational data from the vehicle and providing it to the home system for tabulation and tracking as well as more complex uses such as triggering user notifications and obtaining maintenance recommendations from the information access module component.

The vehicle system 23 attempts to locate and connect to the home system under specific circumstances. Current technology provides for making such a connection only when the vehicle is in close proximity to the media and network capabilities of the home system 21 (for example, when the vehicle is parked near or inside the home's garage where a wireless network access point is located). As the availability and cost of radio frequency connections to vehicles make it possible, the disclosed invention can take advantage of more frequent contact (for example, should satellite-based network connections become generally available and affordable).

To deal with the limitations of current technology (both the limited availability of communications as well as limited available power within the vehicle, the vehicle system 23 attempts to contact the home system only under certain conditions. These are configurable within the vehicle system 23; examples include just after the vehicle ignition is turned off, at predetermined times of the day (e.g., early morning), or when triggered manually by a user. Subject to available power limitations of the vehicle, the vehicle system 23 may also periodically perform a wireless radio frequency (RF) poll to locate the home system access point. Another technique that can be incorporated is the detection of an RF connection or an infrared (IR) connect facility; this would be performed by a low-power detector that would operate even when the vehicle system 23 is powered off. When the potential for a connection is detected, the detector would apply power to the vehicle system 23; the latter would then complete the process of docking. Such measures allow the docking process to occur conveniently without excessive use of the vehicle's available power (e.g., when it is parked and cannot recharge its battery).

Once the vehicle system 23 and home system 21 are connected, they exchange messages over the appropriate communications medium 29. Both this exchange and the prelude actions leading to the connection are protected by suitable privacy measures (e.g., use of public/private keys or similar encryption techniques). The purpose of this messaging is to allow the two systems to synchronize with each other and provide information to each other. Typical information supplied by the vehicle system 23 to the home system 21 includes vehicle performance and operational data (e.g., miles driven, anomalies noted, engine operation measures, etc.) and requests for data made by the user prior to the docking. These requests can be for particular music or other entertainment data, information available from the information access module 405 and resource repository 406, and similar information. Typical information supplied by the home system 21 to the vehicle system 23 include entertainment data (e.g., music data files) and data obtained from the information access module 405 such as information about particular businesses and restaurants (e.g., hours of operation, telephone, address, maps and driving directions to the place of business). When the operator next uses the vehicle, the data is available. An example is the user plans to visit a business on the next day, and requests the home system supply the business's information to the vehicle system so the operator can access it to locate or contact the business.

Other interactions are also possible. A simple example is that an alert can be presented in the home system 21 whenever the vehicle system 23 docks with it; this would allow those in the home to know that the vehicle (and its occupants) have arrived.

FIG. 7 shows the functional areas of the vehicle system 23. Its structure is intentionally similar to the home system 21; the two may share the same implementations for some functions. To aid in describing the vehicle system 23, its components have been given distinct block numbers. The application logic 601 contains the bulk of system logic and operates in a manner similar to the application logic 401 of the home system 23. This is also true for the unified device system 602, the data stores 603, and the communication facility 629 that is used to communicate with the home system 21. The vehicle data sources 731 includes sources that are part of the vehicle itself (e.g., the standard emission test and engine parameters interface on modern autos) or are added as part of the installation of the vehicle system 23. The appropriate communications interface adapter(s) 729 is used to connect with the vehicle system 23. These include both existing communications capabilities installed as original equipment in the vehicle (e.g., the standard OBD2 on board diagnostics interface) as well as add-on capabilities (which may be user-installed or installed as part of the disclosed invention). The vehicle audio/video system 730 is similar; it may be factory installed, aftermarket, or installed as part of the vehicle system 23; the appropriate communication interface(s) 729 are used to connect it to the vehicle system 23. The system 730 is typically a multi-channel, multi-speaker audio system together with video displays in various locations in the vehicle. The vehicle security system 741 is treated in a similar manner.

As with the home system 21, the vehicle system 23 includes the information access module 705 and resources repository 706 with adaptations for the vehicle environment. The update module 407 updates the resource repository 706 from the corresponding repository 406 in the home system 21. The user display and input devices 732 are similar in function to the home system user display and input functions 32 in the home system, but are again adapted to the vehicle environment (e.g., display and input functions may be performed by an in-dash retractable touch screen or similar back-of-seat pop-down screen).

FIG. 7 also shows the vehicle system 23 “docked” to the home system 21. As described previously for FIG. 6, the vehicle system connects with the home system 21 using suitable communication media 629. When the vehicle is no longer able to stay in contact with the home system (e.g., due to distance, low battery condition, manual disconnect, etc.) the link between the two systems is severed. When suitable conditions are manifested, the link is re-established.

The remote operations manager 442 and remote devices module 441 are also shown in FIG. 7. These permit access to and control of devices in other systems (e.g., in another vehicle system 23 or a home system 21). Their function is described further in the description of FIG. 5 above.

FIG. 8 shows the RV System 24. Note that it shares a number of functions with the vehicle system; the vehicle and RV systems take advantage of the common features of autos and RVs. (The block numbers used for blocks in FIG. 8 intentionally match the numbering in FIG. 7 to illustrate the commonality.) The RV system has additional RV-specific sensors 832 for vehicle water supplies, electrical systems, and fuel stores (e.g., propane tanks). It also includes sensors and actuators for parking jacks and parking level sensing 833, and slide-out controls and associated sensors 834 for controlling the RV configure and performing deployment operations. The vehicle system also adds the multi-media trip and activity data store 803.

The information access module 705 module in FIG. 8 is similar to the corresponding the information access module 405 in FIG. 4A. The RV version of the information access module has some functionality that is relevant to the RV environment (as the home system the information access module has some functions specific to the home environment). The RV the information access module manages the resources repository by obtaining information from the Information and connection on-line data repository in two ways. While the RV is docked with the home system 21, it communicates with that system to obtain information updates. The RV system is also capable of updating by communicating directly with the central servers 22; this occurs when the RV is able to communicate through an appropriate medium with the Internet or similar wide-area network. The RV the information access module 705 uses awareness of the current location of the RV (and of planned future movements) to obtain information that is relevant. For example, the module will present the names of nearby RV servicing facilities should a problem with the RV be detected. (This is obviously more useful than merely displaying servicing facilities near the RV owner's home site if the RV is currently on a trip and is 1,000 miles away from the home site.)

The RV system also provides information that is specific to the RV and to RV-related activities. The RV operation, maintenance, and instruction manuals are typically stored in the data storage areas (603 in FIG. 8). The multi-media trip and activity data store 803 includes information useful while traveling in an RV; this includes listings of travel points such as parks, wildlife areas, preserves, and the like; attractions and places of interest to travelers in the various locations; RV event schedules and rallies and similar activities; and “RV-friendly” business and facilities such as service stations with RV-specific capabilities (high clearances, fuels such as propane and diesel, water and waste handling, and high-capacity towing, for example).

The remote operations manager 442 and remote devices module 441 are also shown in FIG. 8. These permit access to and control of devices in other systems (e.g., in another RV system 24 or a home system 21). Their function is described further in the description of FIG. 5 above.

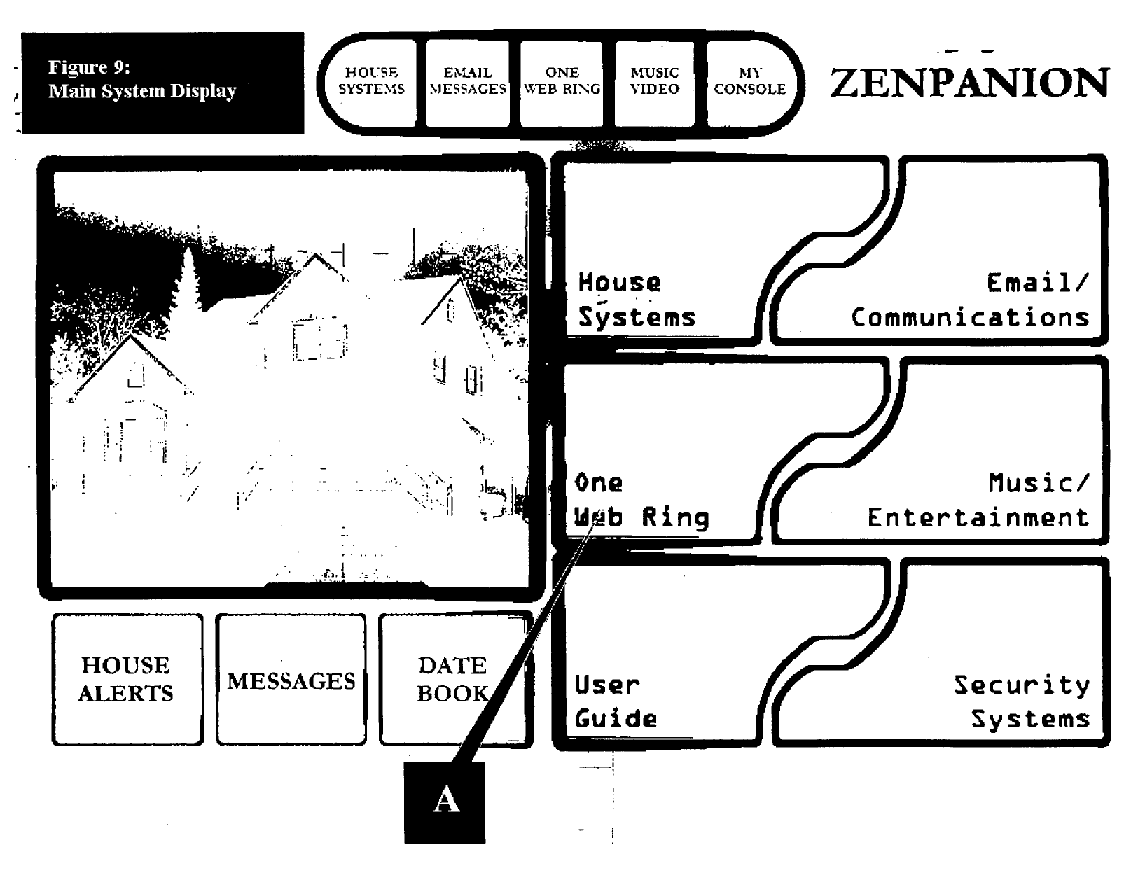

The sequence of FIGS. 9 through 20 show the disclosed invention's displays as seen on its graphical user interface display devices. (These are typically LCD computer style screens having touch-based input capability.) Together the sequence shows two unique attributes of the disclosed invention. First is the integration of information obtained from on-line sources (primarily the Internet) with other functions in the disclosed invention; other systems provide access to similar information but in a manner that is not integrated with system operation. Second is the greatly simplified ability to locate entities such as businesses, restaurants, professionals, and similar persons and venues. These two attributes are elaborated in the following descriptions of the figures.

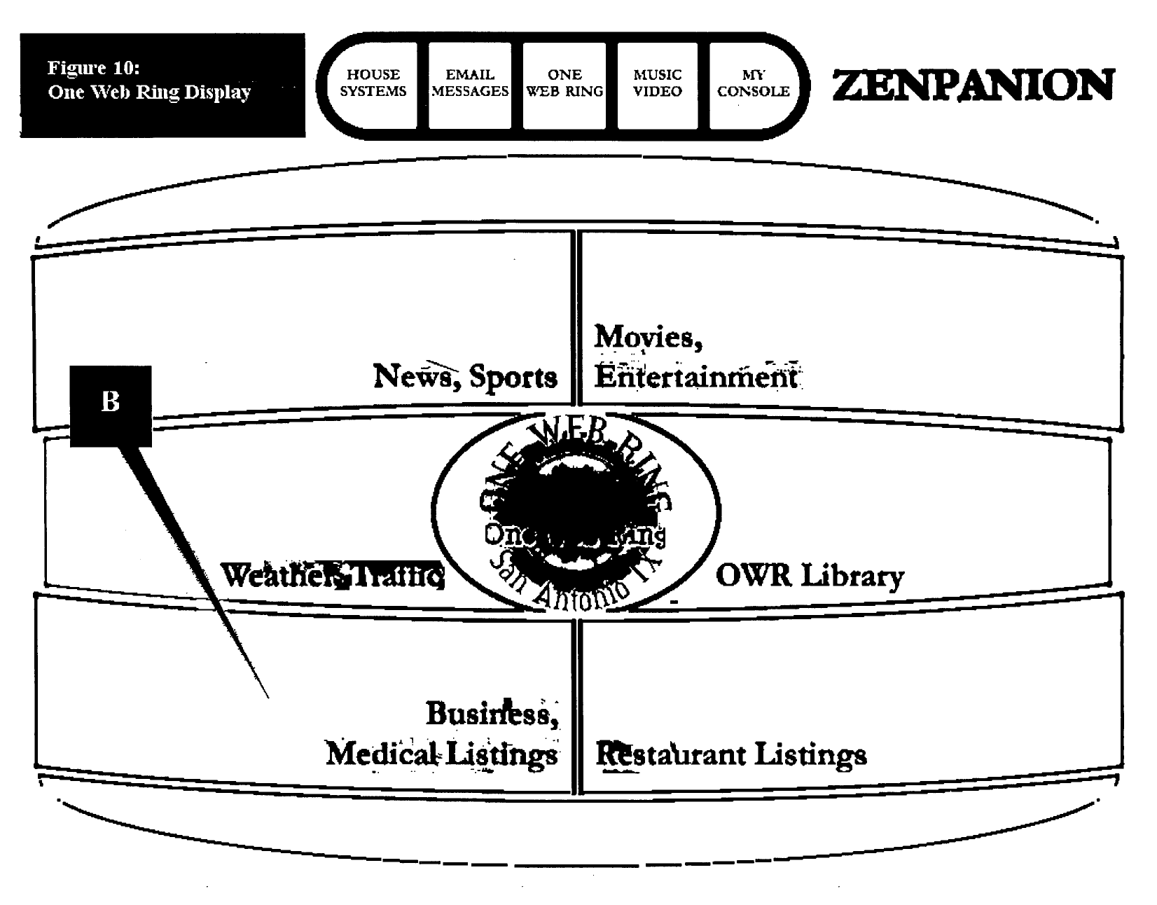

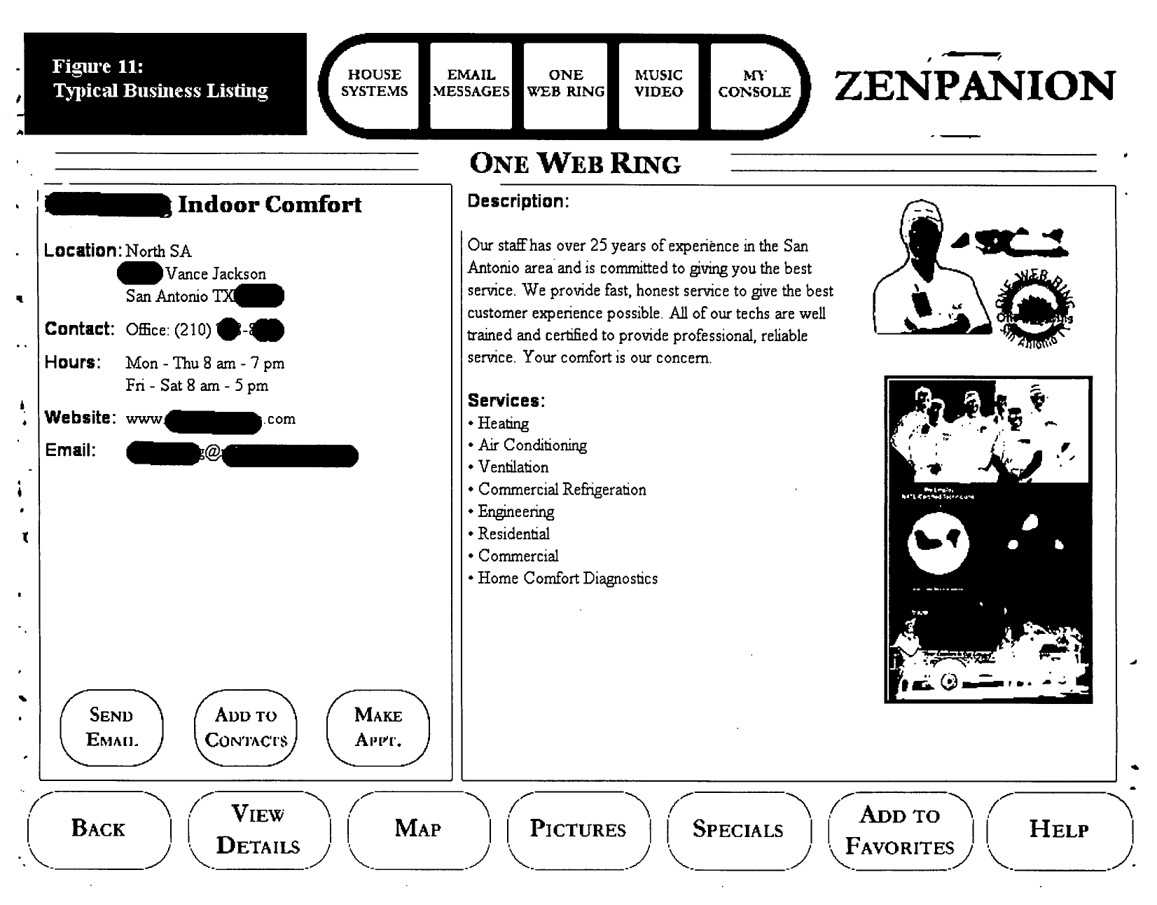

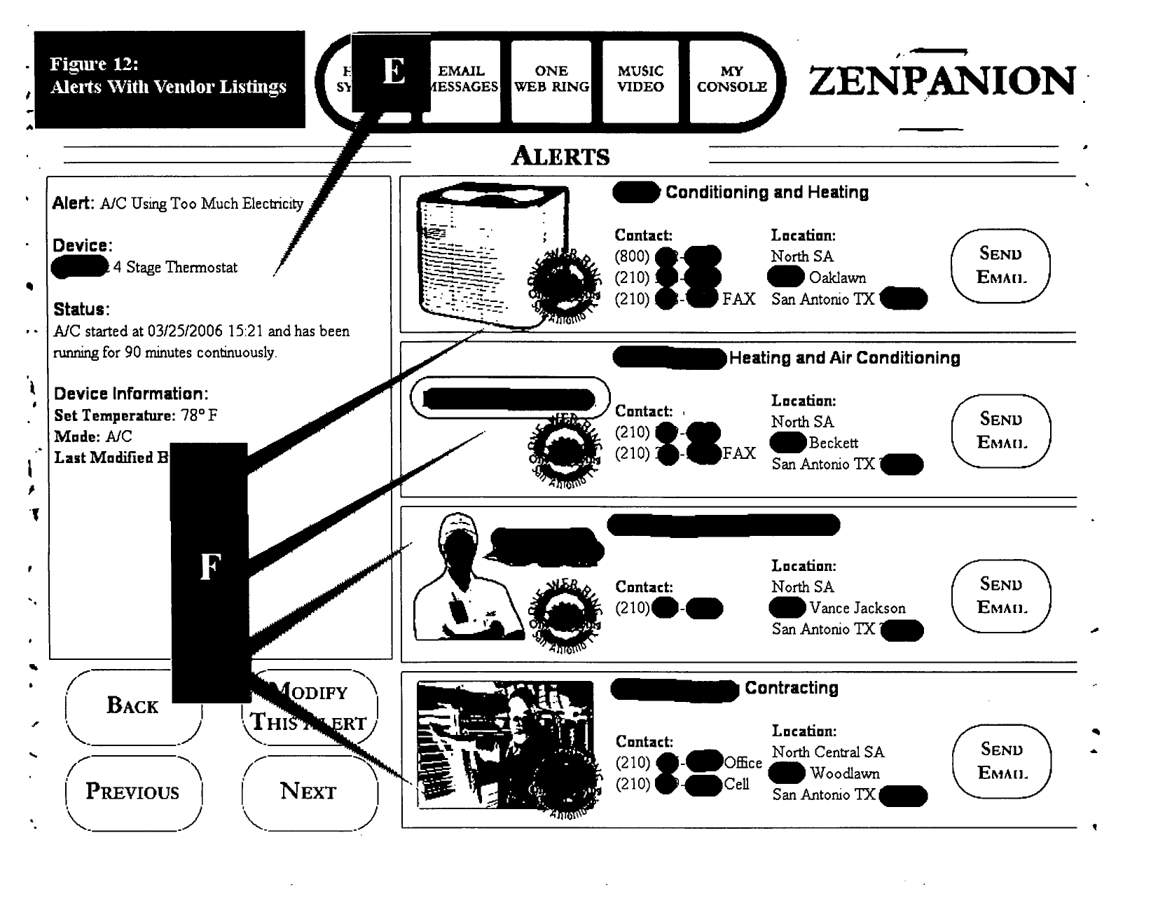

FIG. 9 begins a sequence that ends with FIG. 11; FIG. 12 shows a related display that demonstrates the integration of information resources. FIG. 9 is the ‘main’ display of the disclosed invention; it allows the user to navigate by pressing ‘buttons’ on the display. (This is typically done using touch-based input directly on the display screen; it can also be done by conventional mouse point-and-click operations common to modern computer graphical interfaces. It is generically referred to in this description as ‘pressing a button’) Pressing the button labeled ‘A’ on FIG. 9 takes the user to the display shown in FIG. 10.

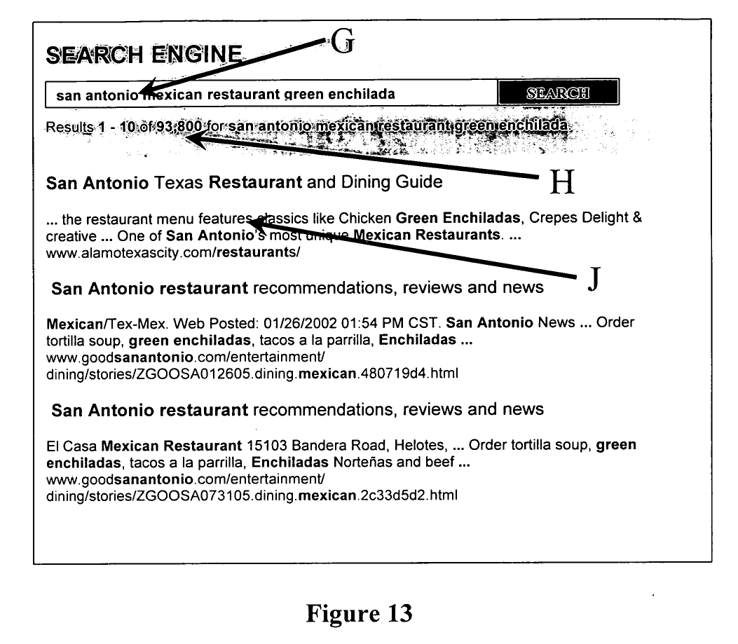

FIG. 10 shows the main display of the resources repository 406 as presented through the information access module 405 (see FIG. 4A). The information and connection facility is an on-line directory and information resource that is available to users of the disclosed invention. (An example of such a set of resources available to the general public on the Internet may be found at www.OneWebRing.com). The six buttons on this display show the categories of information available: (1) news, sports, and other frequently updated information sources; (2) weather, traffic, and travel-related information; (3) information on business and professionals; (4) current movie show times and entertainment schedules and venues; (5) the OWR library, a reference library containing information on a myriad of topics of interest to homeowners and residents; and (6) restaurant listings (subsequent figures show additional restaurant listing displays). Pressing button marked ‘B’ on FIG. 10 takes the user to displays that allow simplified access to businesses. The details of the access process are omitted here for brevity; they are described later (beginning with FIG. 13's description below). Using the access process, the user quickly locates a desired heating and air conditioning vendor. FIG. 11 shows the result of this process, the information and connection listing for the vendor that includes detailed information about the business as well as full-color photos. The process just described allows the user to locate a business, professional, or restaurant (for examples). A unique feature of the disclosed invention is the ability of the system to bring the user intelligently to appropriate business listing (or other appropriate listing) based on some event or situation within the home. For example, if the system detects that the air conditioning system is consuming electricity excessively, it can notify the homeowner using its alert capability. This is shown in FIG. 12. The display in the figure gives the homeowner information about the problem (indicated by pointer ‘E’. At the same time, the information access module provides relevant listings for vendors that are likely choices to remedy the problem (indicated by pointers F). This is a substantial improvement over existing systems since the user is shown relevant information without requiring any user actions whatsoever.

As mentioned previously, the disclosed invention incorporates a unique capability not seen in other home automation systems: the ability to locate information from on-line sources in a simple manner. The typical approach to providing information from the Internet from within a system is to provide access using a conventional “web browser” interface. This is a powerful interface, but it requires considerable technical expertise to use effectively and efficiently. A typical ‘find a restaurant’ search is shown in FIG. 13. The user has used a search engine (for example the most popular such search engine, Google®) to locate a Mexican restaurant in San Antonio that offers green enchiladas (pointer G in FIG. 13). The search has resulted in an enormous number of possible responses (93,800; see pointer H in FIG. 13), more than can possibly be examined in reasonable time by a person. In addition, each item (e.g., pointer J) returned by the search may be quite unrelated to the desired result. As shown by this example, the user is faced with a nontrivial exercise in using the search engine to actually locate a list of the desired restaurants.

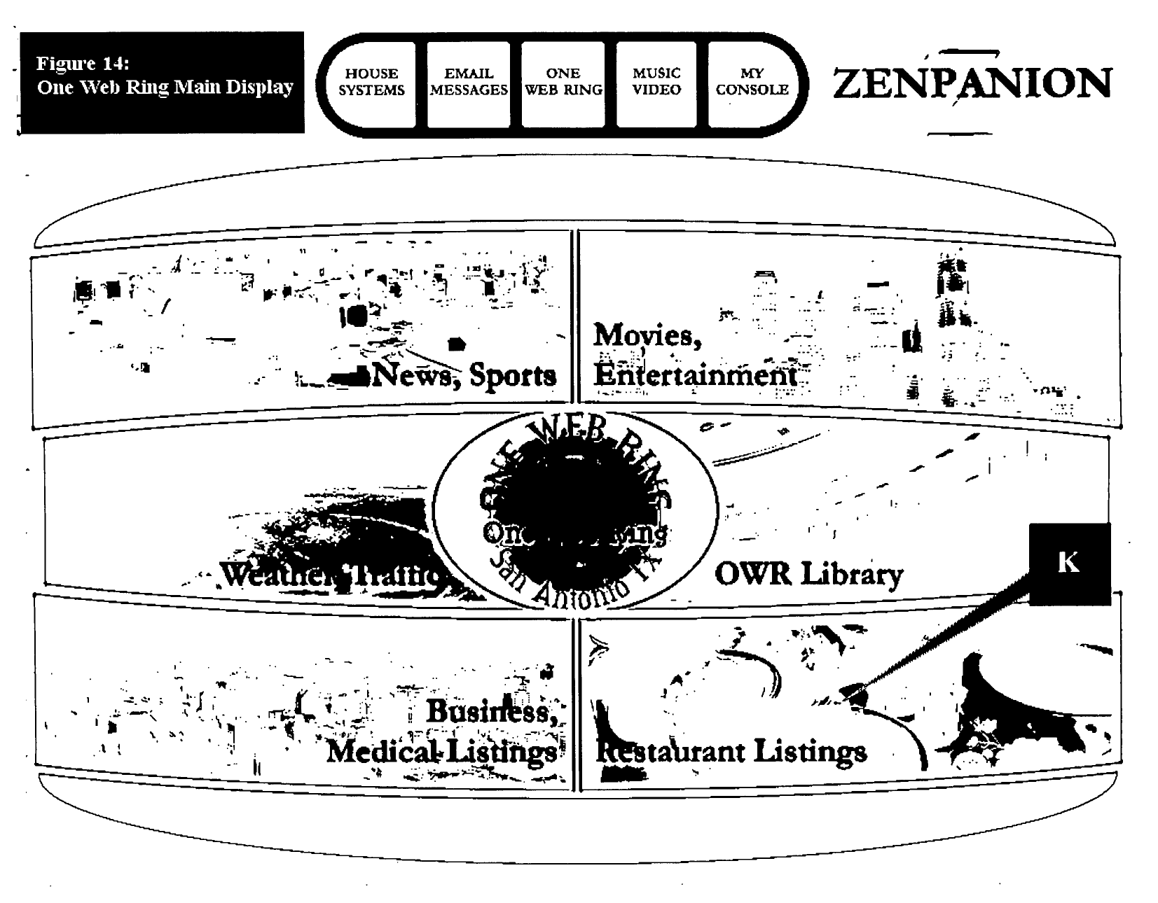

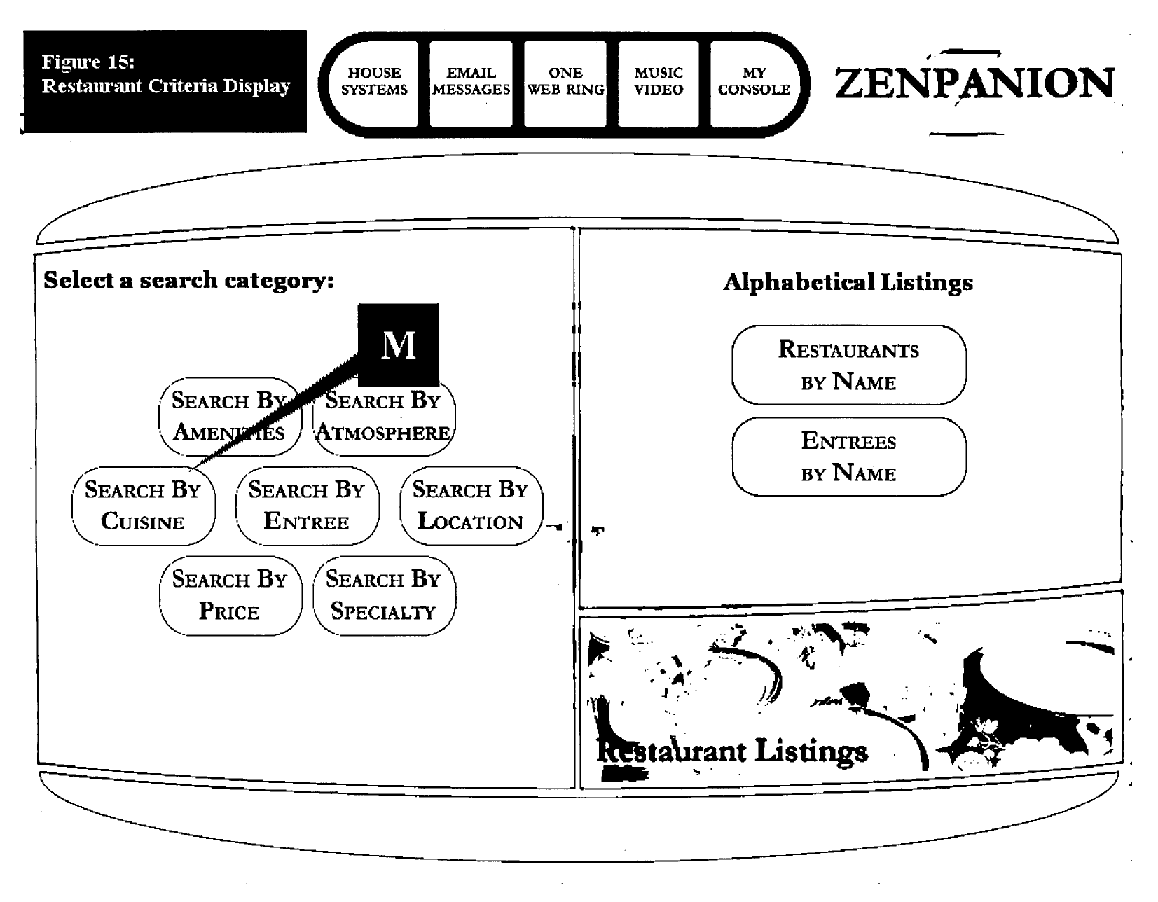

The disclosed invention takes a new approach to the task, one that is unique in home automation systems. The information access module (405 in FIG. 4A) of the disclosed invention provides a simplified, direct capability for locating information about any of the entities available in the resources repository (406 in FIG. 4A). The process begins at the information and connection display of the disclosed invention as shown in FIG. 14. The user chooses the Restaurant Listings button (pointer K). The system responds by showing the display portrayed in FIG. 15.

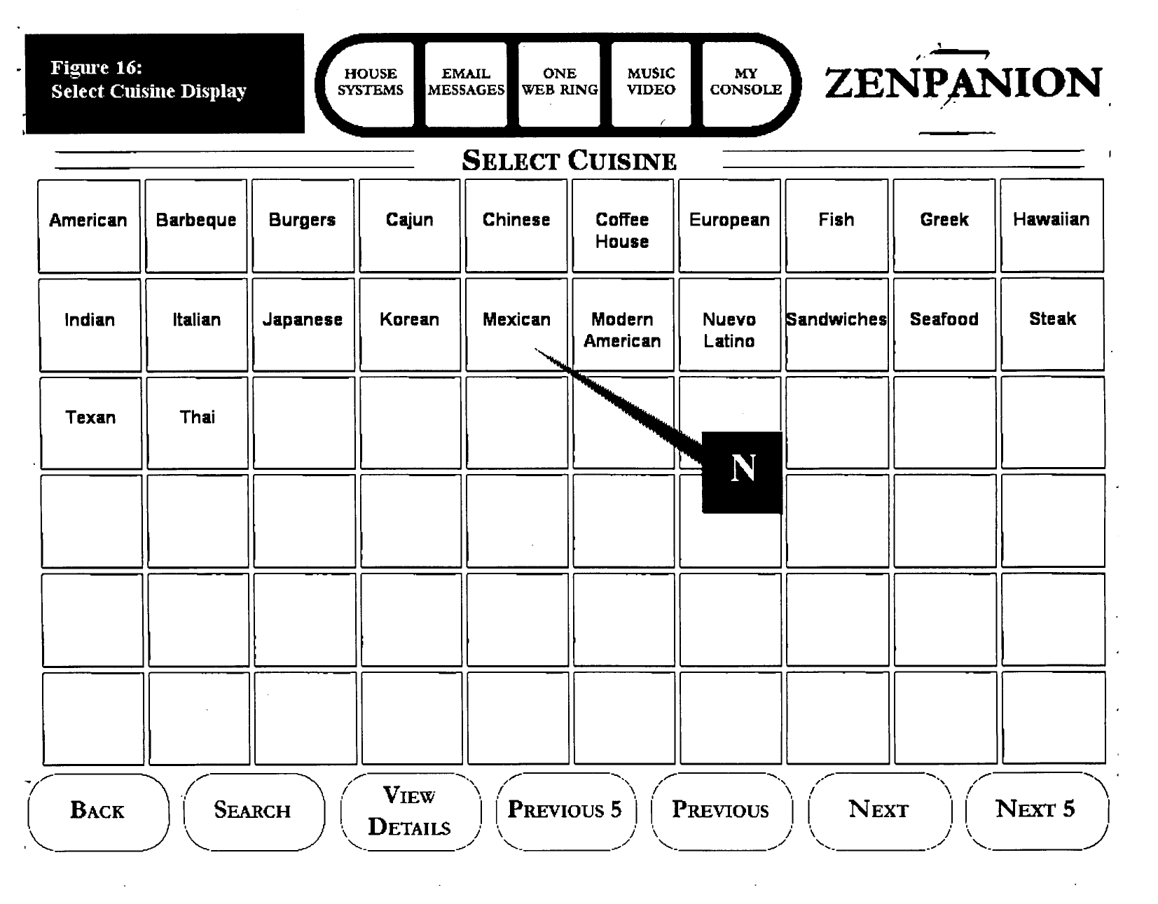

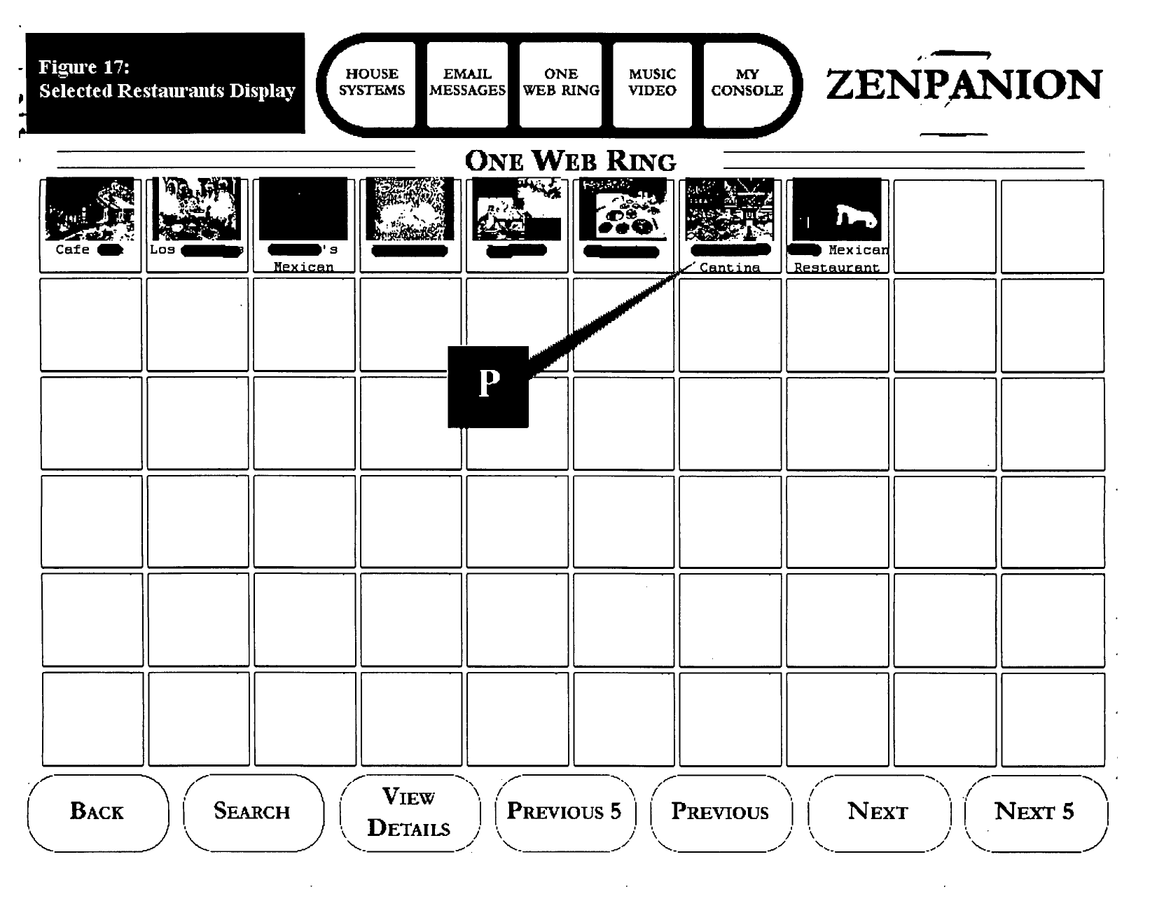

FIG. 15 shows the first step in locating a restaurant using the disclosed invention. For the example (locating a Mexican restaurant that serves green enchiladas), the user performs two actions. The first is to choose the Search by Cuisine button (pointer M in FIG. 15). This brings the user to the display shown in FIG. 16. The user then chooses the Mexican button to select restaurants featuring Mexican cuisine (pointer N in FIG. 16). Using a similar process (not shown for brevity), the user uses the Search by Entrée (see FIG. 15) to see available dishes in the cuisine and chooses “green enchiladas”. When all choices are completed, the user sees the display shown in FIG. 17.

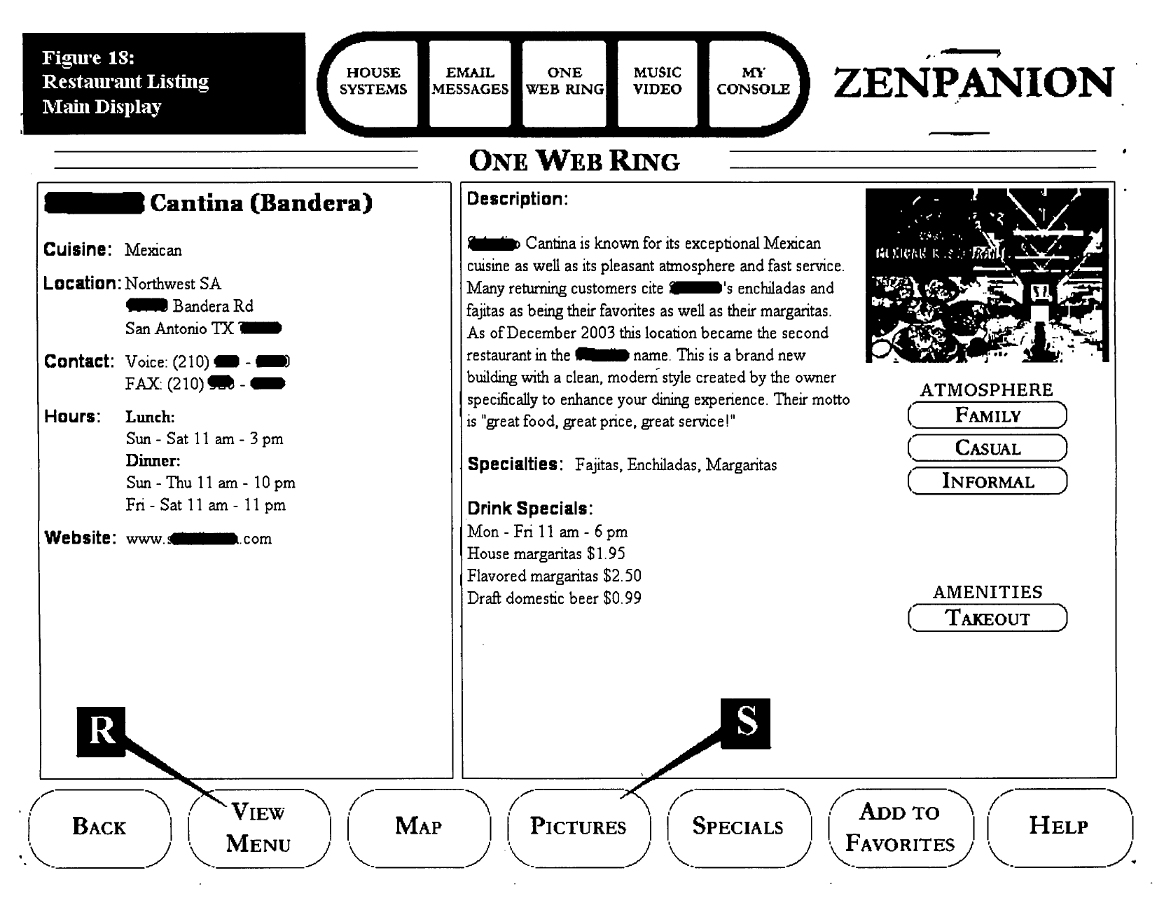

FIG. 17 shows the available restaurants that meet the criteria the user has selected. Each restaurant is represented by a button showing its name and a graphical icon. The user can view the details of each restaurant by pressing its button. For example, presume the user presses the button for Salsalito Cantina (shown by pointer P in FIG. 17). The system responds by showing the display for that restaurant (FIG. 18).

FIG. 18 shows the ‘main’ listing for one of the restaurants that meets the criteria established by the user (FIGS. 15 through 17). Every restaurant listing presented by the disclosed invention has the same format and presentation, making it very easy for the user to do comparisons. Additional information is available from this display by pressing one of the buttons at the bottom of the display. View Menu shows the complete restaurant menu with prices, Map shows a map and driving directions, Pictures shows photos and images of the restaurant and its food, and specials shows specialty items. The Add to Favorites button allows the user to put this restaurant on a ‘favorites’ list for quick access.

Note the substantial difference between the information in FIG. 13 from the Figures showing the displays of the disclosed invention. The disclosed invention provides a simple, direct process for locating listings for desired businesses, restaurants, or professionals. Each listing is shown in the same format with a complete set of information (menu, maps, etc.) By comparison an Internet search requires the user to sift through many web sites, each of which has its own unique presentation, layout, and available information. This makes the process very much more difficult than that of the disclosed invention.

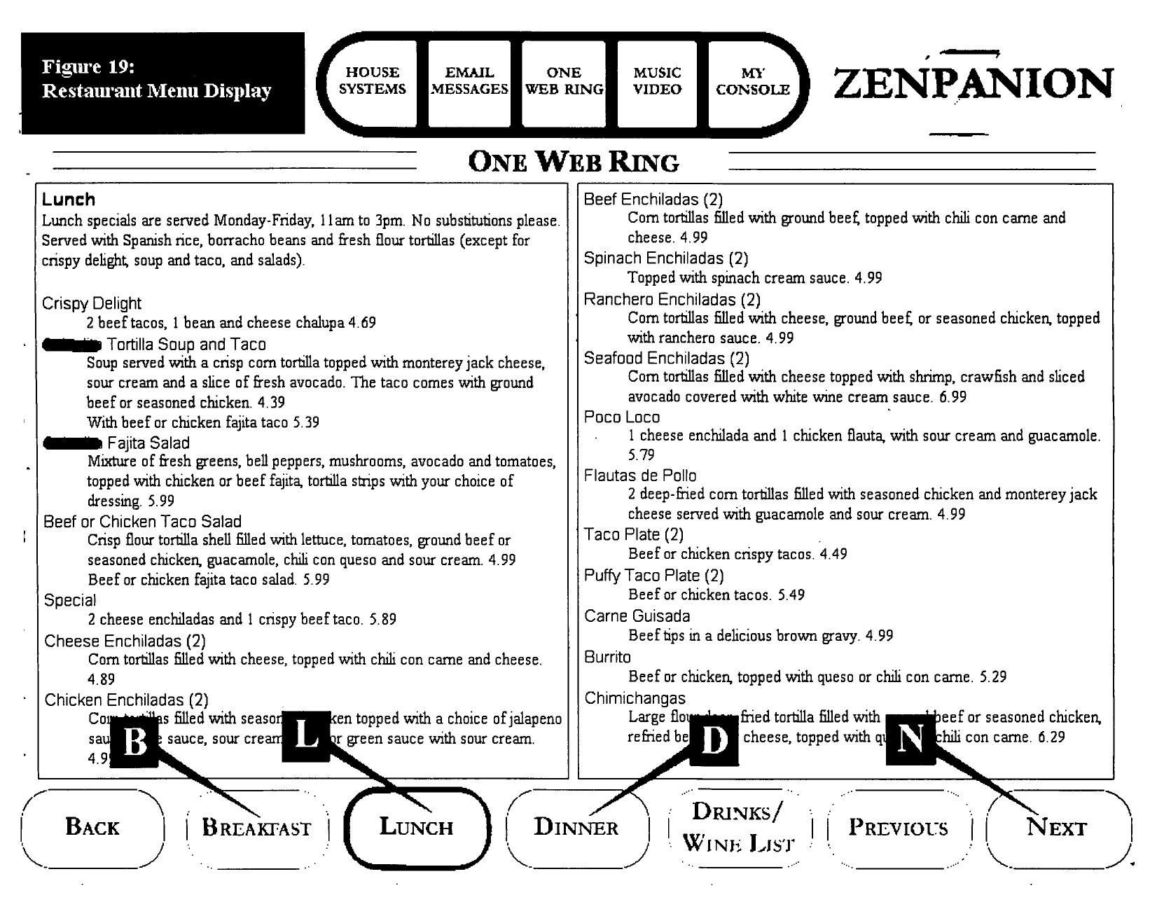

If the user presses the View Menu button (pointer R in FIG. 18), the system responds with the display shown in FIG. 19. This display shows the full menu of the selected restaurant. Using the Previous and Next buttons (pointers N in FIG. 18), the user can step through the pages of the menu. (The Previous button is shown subdued because it is disabled at this point: there is no previous page available as this is the first page of the menu). The breakfast, lunch, and dinner buttons (pointers B, L, and D in FIG. 18) select the appropriate menu; note in this example the restaurant does not serve breakfast and so has no breakfast menu.

Not shown is the ability for the user to place an order for items by using the menu display. The user uses the touch screen, touching the items on the menu that are desired. The order is placed using a suitable communication path directly from the information access module to the restaurant. This typically is done using email, electronic facsimile transfer, or a network-based protocol specific to the disclosed invention.

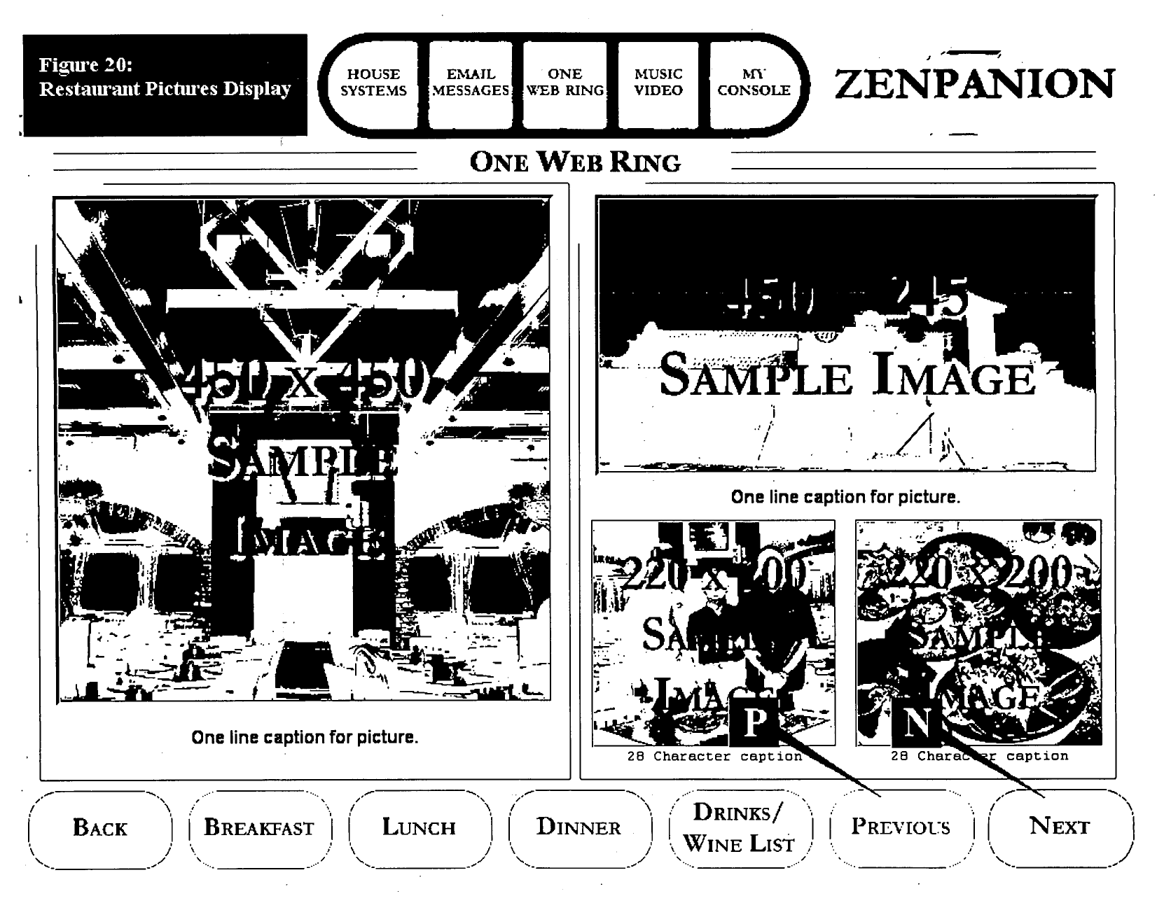

If the user presses the Pictures button (pointer S in FIG. 18), the system provides the display of FIG. 20. As shown in the figure, images of several sizes can be shown in various combinations; the size in pixels of each image is shown on the image. Each image also features a caption. As with the menu display, additional images are available by pressing the Previous and Next buttons (pointers P and N in FIG. 20).

Other systems may provide the ability to locate information for a business or similar entity, but only through the normal mechanism used for searching and browsing the Internet. The disclosed invention not only provides a uniquely simplified means to access such information, but also can provide the information in a manner that appears seamlessly within the operation of the system as shown by the alerts example previously discussed (FIGS. 9 through 12). This aspect of the present invention may be characterized as an information and action “routing service” that is tailored to the specific needs of the user.

The disclosed invention including its systems, subsystems, functions, and techniques are disclosed only as examples and illustrations of the disclosed invention. Those skilled in the suitable arts can be expected to immediately see various improvements, refinements, and enhancements that can be applied to the disclosed invention without departing from the spirit and scope of the invention. Accordingly, the invention is limited only by the following claims:

We Claim:

1. A system for controlling the operation of a plurality of objects within a defined human environment, the system comprising:
a central processing unit, the processing unit having a memory storage device and a real time clock;
a plurality of condition sensors, the sensors providing condition data about the defined human environment to the central processing unit;
at least one local data input device, the local device allowing a user of the system to provide data to the central processing unit;
at least one remote data input device, the remote device allowing a user of the system to provide data to the central processing unit;
a plurality of controller devices for the controlled operation of the plurality of objects within the defined human environment, the controller devices operable by the central processing unit.

2. The system of claim 1 wherein the defined human environment is configured as a single family dwelling.

3. The system of claim 1 wherein the defined human environment is configured as a single recreational vehicle.

4. The system of claim 1 wherein the defined human environment is configured as a single automotive vehicle.

5. The system of claim 1 wherein the defined human environment comprises two or more defined environments selected from defined environments comprising: single family dwellings, recreational vehicles, and automotive vehicles.

6. The system of claim 1 wherein said plurality of objects comprises at least one lighting system device.

7. The system of claim 1 wherein said plurality of objects comprises at least one audio/video system device.

8. The system of claim 1 wherein said plurality of objects comprises at least one climate control system device.

9. The system of claim 1 wherein said plurality of objects comprises at least one security system device.

10. The system of claim 1 wherein said plurality of objects comprises at least one fluid handling system device.

11. The system of claim 1 wherein said plurality of objects comprises at least one communication systems device.

12. A method for operating a defined human environment automation system, the method comprising the controlled operation of a plurality of objects within the defined human environment, the system comprising a central processing unit and a plurality of controller devices associated with the plurality of objects within the defined human environment, the method comprising the steps of:
defining at least one operational state capable of being established within at least a portion of the defined human environment, the at least one operational state generally characterized by an activity or activities to be carried out in the portion of the defined human environment;
organizing the plurality of objects within the defined human environment into functional groups based on pre-defined association criteria derived from the at least one operational state;
selecting and establishing one of the operational states within the defined human environment by providing control commands from the central processing unit to the plurality of controller devices, and thereby to the plurality of objects within one or more of the functional groups.

13. The method of claim 12 wherein the step of selecting and establishing an operational state comprises the step of identifying a triggering event, pre-defined as associated with the establishment of the operational state.

14. The method of claim 13 wherein the triggering event comprises a direct instruction from the user of the defined human environment.

15. The method of claim 13 wherein the triggering event comprises a condition sensed within the defined human environment.

16. The method of claim 13 wherein the triggering event comprises a period of time from a user selected starting time.

17. The method of claim 13 wherein the triggering event comprises a specific time in real time chronology.

18. The method of claim 12 wherein the at least one operational state comprises a waking-up scenario, the activity or activities to be carried out in the portion of the defined human environment comprising those associated with individuals within the defined human environment waking from sleep and preparing for daily activities.

19. The method of claim 12 wherein the at least one operational state comprises an entertainment scenario, the activity or activities to be carried out in the portion of the defined humane environment comprising those associated with individuals within the defined human environment being entertained.

20. The method of claim 12 wherein the at least one operational state comprises a vacation absence scenario, the activity or activities to be carried out in the portion of the defined human environment comprising those associated with maintaining security and an appearance of individuals being present within the defined human environment.

21. The method of claim 12 wherein the operational states each comprise a plurality of program controlled operations involving the plurality of objects within the defined human environment, the program control being directed by the central processing unit.

22. The method of claim 21 further comprising the step of maintaining a timing device and wherein the program controlled operations are carried out according to a timed sequence.

23. The method of claim 21 further comprising the step of receiving input from an individual within the defined human environment and wherein the program controlled operations are carried out according to direct instructions input from the individual.

24. The method of claim 21 further comprising the step of sensing at least one environmental condition within the defined human environment and wherein the program controlled operations are carried out in response to the sensed environmental conditions.

25. A method for operating a defined human environment automation system, the method comprising the controlled operation of a plurality of objects within the defined human environment, the system comprising a central processing unit and a plurality of controller devices associated with the plurality of objects within the defined human environment, the method comprising the steps of:
selecting and establishing one of a plurality of operational states within the defined human environment by providing control commands from the central processing unit to the plurality of controller devices, and thereby to the plurality of objects within one or more of the functional groups;
providing access and connection to remote processing systems to transmit and receive information and to effect activities outside the defined human environment that connect with actions and activities within the defined human environment.

26. The method of claim 25 wherein the access and connection to remote processing systems is carried out through a coordinated information and action routing service connected to remote servers through a wide area network.
